(19) United States
(12) Patent Application Publication
(10) Pub. No.: US 2003/0185301 A1
(43) Pub. Date: Oct. 2, 2003

(54) Video appliance

(76) Inventors: Thomas Algie Abrams JR., Snohomish, WA (US); Mark F. Beauchamp, Seattle, WA (US)

Correspondence Address: LEE & HAYES PLLC, 421 W RIVERSIDE AVENUE SUITE 500, SPOKANE, WA, 99201

(21) Appl. No.: 10/115,681

(22) Filed: Apr. 2, 2002

(51) Int. Cl. H04N 7/12

(52) U.S. Cl. 375/240.12; 375/240.01; 375/240.18

(57) ABSTRACT

Methods, devices, systems and/or storage media for video and/or audio processing. An exemplary video appliance includes one or more units having framework capabilities and a controller for controlling one or more of the units via the framework capabilities. An exemplary video appliance optionally includes an intranet.

### CROSS-REFERENCE TO RELATED APPLICATION

This application is related to an application entitled “Camera and/or camera converter”, to inventor Thomas Algie Abrams, Jr., assigned to Microsoft Corporation, filed concurrently on Apr. 1, 2002 and having Ser. No. ______ and attorney Docket No. MS1-1081US, the contents of which are incorporated by reference herein.

### TECHNICAL FIELD

This invention relates generally to methods, devices, systems and/or storage media for video and/or audio processing.

### BACKGROUND

Techniques and equipment for production and post-production of video often rely on magnetic tape as a storage medium. In particular, a video tape recorder (VTR or VCR) can receive, encode, store and decode video and therefore, it has become a cornerstone of many production and post-production processes. In general, a professional television system includes acquisition, processing, and distribution phases. An acquisition phase typically involves capturing raw content (e.g., audio and video) and storing the content to tape and/or broadcasting the content live. A processing phase typically involves input of raw or stored content, processing the content to ensure compliance with content and/or structure required by output venues, and storing the processed content to tape. A distribution phase typically involves transport of acquired and/or processed content (e.g., as stored on tape) to a target viewer or viewers, for example, via radio frequency and/or other transmission means. Therefore, tape-based storage serves an important role in many professional systems.

In response to industry-wide acceptance of tape-based storage, a variety of industry standards specifying tape formats were developed. For example, the D1 and D2 digital tape formats specify storage of uncompressed video and the D6 digital tape format specifies storage of compressed video. In addition, the digital tape formats often specify maximum bit rates for data transmission, which are typically inversely associated with compression ratio. For example, the D1 format specifies no compression and a maximum rate of 270 Mbps. Compressed formats such as DVCPRO® (Matsushita Electric Industrial, Ltd., Japan) and BETACAM® SX (Sony Corporation, Japan) include compression ratios of 3.3:1 (intraframe) and 10:1 (interframe), respectively, and generally specify lower bit rates. In intraframe compression, compressed information for a particular video frame (e.g., an index frame or “I frame”) does not rely on information contained in another video frame. In contrast, interframe compression relies on information from more than one video frame to form what are sometimes referred to as predictive frames (P frames) or bidirectional predictive frames (B frames) which typically follow an “I frame” to form a “group of pictures” (GOP). In general, interframe compression techniques allow for higher compression ratios when compared to intraframe compression techniques.

More recently, various standards have emerged for storing data on disk as opposed to tape, for example, using a digital disk recorder (DDR). Disk storage offers advantages in terms of access time and, for example, the ability to retroloop, i.e., to record for about 15 minutes and, without stopping, to continue to record while erasing what was recorded 15 minutes earlier. In particular, the DVCPRO® standard, while originally developed for tape, now includes specifications for storage of video onto a disk or disks. In addition, the MPEG-2 compression standard, which is used by the BETACAM® SX, is also suitable for storage of video on a disk, e.g., a DVD disk.

Regarding compression techniques, the DVCPRO® 50 standard uses two compression chip sets operating in parallel wherein each chip processes a data stream carrying video data in a 2:1:1 color sampling format. In combination, the two chips generate compressed video in a 4:2:2 color sampling format, which is virtually lossless when compared to the original video. The DVCPRO® 50 standard further specifies a data rate of 50 Mbps and suggests use of video having a 480 line progressive video format and upconversion to higher definition video using a format converter rather than direct acquisition of video having a 720 line progressive or 1080 line interlace video format. As already mentioned, the BETACAM® SX standard specifies use of the MPEG-2 compression standard and a data rate of 18 Mbps; however, at this data rate and a compression ratio of 10:1, the video feed is limited to approximately 180 Mbps.

Regarding the MPEG-2 compression standard, while used in products such as digital television (DTV) set top boxes and DVDs, it is not a tape or a transmission standard. As an example, consider a DVD player with a single sided DVD disk that can store approximately 38 Gb. To fit two hours of video having a resolution of 1280 pixel by 720 lines, a frame rate of 24 frames per second (fps) and a color depth of 24 bits onto this disk, consider first, a re-sampling process that downgrades the video quality to a format having a resolution of 720 pixel by 486 line, a frame rate of approximately 24 fps and a color depth of 16 bits. Now, instead of a bit rate of 530 Mbps and a file size of 4 Tb, the content has a bit rate of approximately 130 Mbps and a file size of approximately 1 Tb. To fit the 1 Tb of content on a 38 Gb single sided DVD disk, a compression ratio of approximately 30:1 is required. When storage of audio and sub-titles is desired, an even higher compression ratio, for example, of approximately 40:1, is required.

In general, MPEG-2 compression ratios are typically confined to somewhere between approximately 8:1 and approximately 30:1, which some have referred to as the MPEG-2 compression “sweet spot”. Further, with MPEG-2, transparency (i.e., no noticeable discrepancies between original or source video and reconstructed video) occurs only for conservative compression ratios, for example, between approximately 8:1 and approximately 12:1. Thus, to achieve a high degree of transparency, source content is often pre-processed (e.g., re-sampled) prior to MPEG-2 compression or lower resolution source content is used, for example, 352 pixel by 480 lines at a frame rate of 24 fps and a color depth of 16 bits. In practice, however, for a variety of reasons, MPEG-2 compression ratios are typically around 30:1. For example, a reported MPEG-2 rate-based “sweet spot” specifies a bit rate of 2 Mbps for 352 pixel by 480 line and 24 fps content, which reportedly produces an almost NTSC broadcast quality result that is also a “good” substitute for VHS. To achieve a 2 Mbps rate for the 352 pixel by 480 line and 24 fps content requires a compression ratio of approximately 30:1, which again, is outside the conservative compression range. Thus, while the BETACAM® SX specifies a compression ratio in the conservative range, most commercial applications that rely on MPEG-2 for video, have some degree of quality degradation and/or quality limitations.

One way to increase video quality involves maintaining a higher resolution (e.g., maintaining more pixels). Another way to increase video quality involves use of better compression algorithms, for example, algorithms that maintain subjective transparency for compression ratios greater than approximately 12:1 and/or achieve VHS quality at compression ratios greater than 30:1. Of course, a combination of both higher resolution and better compression algorithms can be expected to produce the greatest increase in video quality. For example, it would be desirable to maintain the 1280 pixel by 720 line resolution of the aforementioned digital video and to transmit such content in a data stream. In addition, it would be desirable to have a non-tape-based device that can maintain, for example, a 720 line video format and that includes at least some of the operational features typically found on a VTR. Of course, it would also be desirable to handle full resolution NTSC format video, which has a bit rate of approximately 165 Mbps (e.g., a resolution of approximately 720 pixel by approximately 486 line, interlaced, a field rate of approximately 60 fields per second wherein each field has a line resolution of approximately 243 lines and there are two fields per frame, and approximately 16 bits per pixel assuming a 4:2:2 color sampling format) and/or other video formats (e.g., SD, HD and/or other) at the aforementioned MPEG-2 and/or higher compression ratios while maintaining or exceeding the video quality associated with MPEG-2-based compression. Technologies for accomplishing such tasks, as well as other tasks, are presented below.

### SUMMARY

An exemplary video appliance includes one or more processor-based units capable of encoding and/or decoding digital video data. Such an exemplary video appliance optionally includes an intranet. An exemplary method includes serving code to an encoder unit and/or a decoder unit having a runtime engine. According to such an exemplary method, the runtime engine executes the code to thereby cause a unit to encode and/or decode digital video data. Further, the exemplary method optionally includes serving code via a video appliance intranet. Exemplary methods, devices and/or systems optionally include audio capabilities, capabilities for video and/or audio metadata (VAM), and/or a data architecture.

Additional features and advantages of the various exemplary methods, devices, systems, and/or storage media will be made apparent from the following detailed description of illustrative embodiments, which proceeds with reference to the accompanying figures.

### BRIEF DESCRIPTION OF THE DRAWINGS

A more complete understanding of the various methods and arrangements described herein, and equivalents thereof, may be had by reference to the following detailed description when taken in conjunction with the accompanying drawings wherein:

FIG. 1 is a block diagram illustrating an exemplary appliance for receiving and/or communicating video and/or audio.

FIG. 2 is a block diagram illustrating an exemplary appliance and a non-exclusive variety of hardware and/or software blocks, some of which are optional.

FIG. 3 is a block diagram illustrating an exemplary appliance for receiving and/or communicating digital video data via one or more serial digital interfaces.

FIG. 4 is a block diagram illustrating an exemplary appliance for receiving and/or communicating digital video data via one or more serial digital interfaces and one or more network interfaces.

FIG. 5 is a block diagram illustrating an exemplary appliance having an encoder unit and a decoder unit.

FIG. 6 is a block diagram illustrating an exemplary appliance having an encoder unit, a decoder unit, a server unit and a controller unit.

FIG. 7 is a block diagram illustrating another exemplary appliance having an encoder unit, a decoder unit, a server unit and a controller unit.

FIG. 8 is a block diagram illustrating an exemplary unit suitable for use an encoder unit, a decoder unit, a server unit and/or a controller unit.

FIG. 9 is a block diagram illustrating an exemplary method for converting information to a particular format using video and/or audio codecs.

FIG. 10 is a block diagram illustrating an exemplary process for compression and decompression of image data.

FIG. 11 is a block diagram of an exemplary appliance that includes one or more processor-based devices and a serial digital to PCI and/or VME interface.

FIG. 12 is a block diagram illustrating an exemplary controller unit and two other exemplary units together with a variety of software blocks.

FIG. 13 is a block diagram illustrating an exemplary method for receiving digital video, compressing digital video, storing digital video and/or playing digital video.

FIG. 14 is a block diagram illustrating an exemplary network environment that includes sources, networks, appliances and/or clients.

FIG. 15 is a block diagram illustrating an exemplary network environment that includes sources (e.g., cameras, etc.), networks, appliances, clients, and/or display units.

FIG. 16 is a graph of video data rate in Gbps versus processor speed in GHz for a process-based device having a single processor.

### DETAILED DESCRIPTION

Turning to the drawings, wherein like reference numerals refer to like elements, various methods are illustrated as being implemented in a suitable computing environment. Although not required, the methods will be described in the general context of computer-executable instructions, such as program modules, being executed by a personal computer and/or other computing device. Generally, program modules include routines, programs, objects, components, data structures, etc. that perform particular tasks or implement particular abstract data types. Moreover, those skilled in the art will appreciate that various exemplary methods may be practiced with other computer system configurations, including hand-held devices, multi-processor systems, microprocessor based or programmable consumer electronics, network PCs, minicomputers, mainframe computers, and the like. Various exemplary methods may also be practiced in distributed computing environments where tasks are performed by remote processing devices that are linked through a communications network. In a distributed computing environment, program modules may be located in both local and remote memory storage devices.

In some diagrams herein, various algorithmic acts are summarized in individual “blocks”. Such blocks describe specific actions or decisions that are made or carried out as a process proceeds. Where a microcontroller (or equivalent) is employed, the flow charts presented herein provide a basis for a “control program” or software/firmware that may be used by such a microcontroller (or equivalent) to effectuate the desired control of the stimulation device. As such, the processes are implemented as machine-readable instructions storable in memory that, when executed by a processor, perform the various acts illustrated as blocks.

Those skilled in the art may readily write such a control program based on the flow charts and other descriptions presented herein. It is to be understood and appreciated that the subject matter described herein includes not only devices and/or systems when programmed to perform the acts described below, but the software that is configured to program the microcontrollers and, additionally, any and all computer-readable media on which such software might be embodied. Examples of such computer-readable media include, without limitation, floppy disks, hard disks, CDs, RAM, ROM, flash memory and the like.

Overview

Various technologies are described herein that pertain generally to digital video and/or audio. Many of these technologies can lessen and/or eliminate the need for a downward progression in video quality. Other technologies allow for new manners of distribution and/or display of digital video. As discussed in further detail below, such technologies include, but are not limited to: exemplary methods for producing a digital video stream and/or a digital video file; exemplary methods for controlling video acquisition, production and/or post-production processes; exemplary methods for producing a transportable storage medium containing digital video; exemplary methods for displaying digital video; exemplary devices and/or systems for producing a digital video stream and/or a digital video file; exemplary devices and/or systems for video processing having framework capabilities; exemplary devices and/or systems for storing digital video on a transportable storage medium; exemplary devices and/or systems for displaying digital video; and exemplary storage media for storing digital video.

Various exemplary methods, devices, systems, and/or storage media are described with reference to front-end, intermediate, back-end, and/or front-to-back processes and/or systems. While specific examples of commercially available hardware, software and/or media are often given throughout the description below in presenting front-end, intermediate, back-end and/or front-to-back processes and/or systems, the exemplary methods, devices, systems and/or storage media, are not limited to such commercially available items.

Description of Exemplary Methods, Devices, Systems, and/or Media

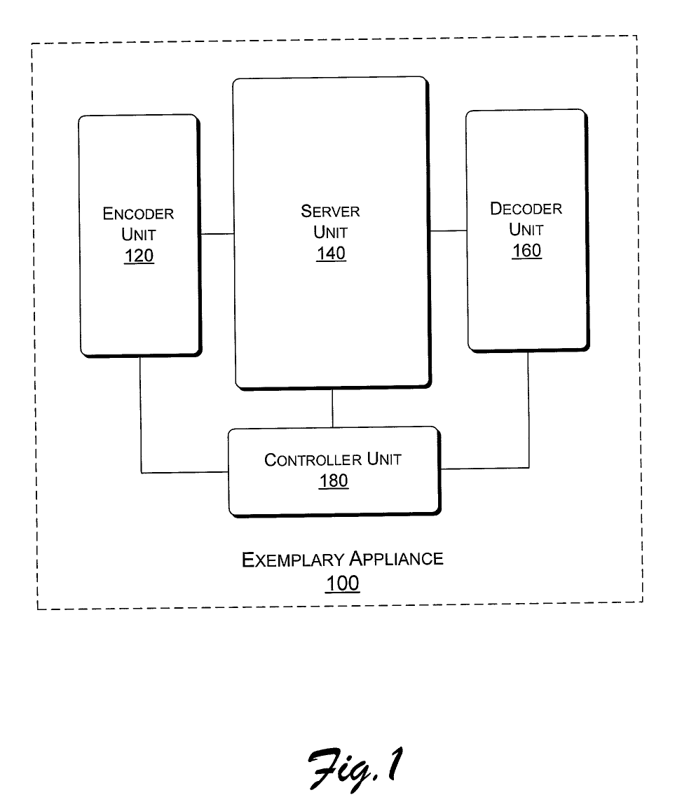

Referring to FIG. 1, a block diagram of an exemplary appliance 100 is shown. The exemplary appliance 100, which may be considered a device, includes hardware and software to allow for a variety of tasks, such as, but not limited to, input of video, compression of video, storage of video, decompression of video and output of video. Note that throughout the description herein, video optionally includes audio. To accomplish the aforementioned tasks, the exemplary appliance 100 includes an encoder unit 120, a server unit 140, a decoder unit 160 and a controller unit 180. As shown in this exemplary appliance 100, communication links exist between the various units 120, 140, 160 and 180. In particular, as described in more detail below, the controller unit 180 allows for control of the encoder unit 120, the server unit 140 and the decoder unit 160. Further, while the units 120, 140, 160 and 180 of the exemplary appliance 100 optionally operate on one processor-based device, in this exemplary appliance 100 and/or in various alternative exemplary appliances, various units operate on disparate processor-based devices which are controllable via a controller unit.

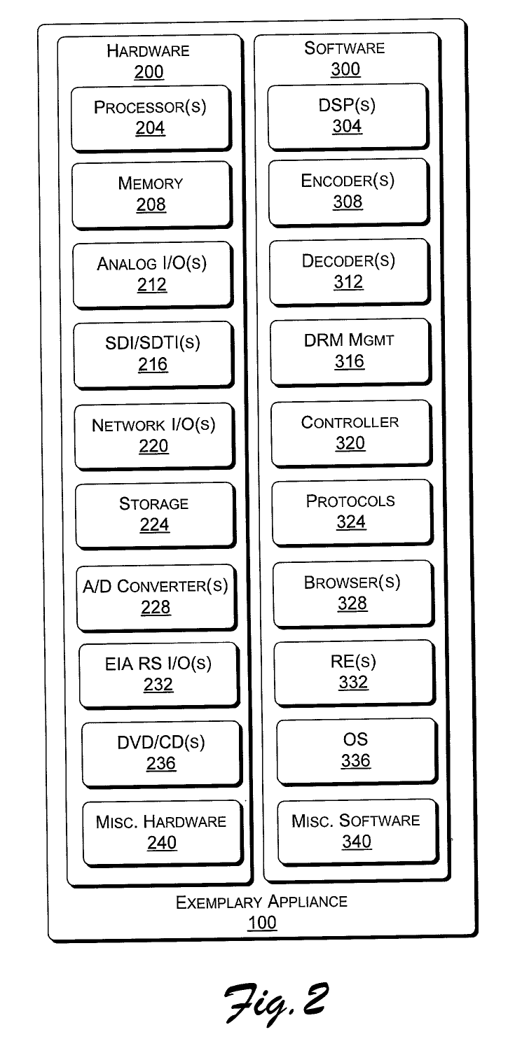

Referring to FIG. 2, a block diagram of an exemplary appliance 100 is shown. While FIG. 2 shows a variety of functional blocks, some of the blocks are optional, as discussed in further detail below. The appliance 100 includes various functional blocks which are commonly found in a computing environment. The various components or blocks within the appliance 100 are categorized generally as hardware blocks 200 or software blocks 300, while it is understood that some hardware functions are achievable via software equivalents and that some software functions are achievable via hardware equivalents. With reference to FIG. 2, an exemplary appliance 100 computing environment typically includes one or more processors (e.g., processor block 204), memory (e.g., memory block 208), and a bus (not shown) that couples various components including the memory to the processor. The bus may be any of several types of bus structures including a memory bus or memory controller, a peripheral bus, and a local bus using any of a variety of bus architectures. In general, the memory block 208 includes read only memory (ROM) and/or random access memory (RAM). The appliance 100 further optionally includes a basic input/output system (BIOS) that contains routines, e.g., stored in ROM, to help transfer information between elements within the computing environment, such as during start-up. The exemplary appliance 100 further includes one or more storage devices (e.g., blocks 224, 236) such as, but not limited to, a disk drive for reading from and writing to a hard disk, a magnetic disk drive for reading from or writing to a removable magnetic disk, and an optical disk drive for reading from or writing to a removable optical disk such as a CD ROM or other optical media. The hard disk drive, magnetic disk drive, and optical disk drive are typically connected to the bus by a hard disk drive interface, a magnetic disk drive interface, and an optical drive interface, respectively. The drives and their associated computer-readable media provide nonvolatile storage of computer readable instructions, data structures, program modules and other data for the computing environment. The exemplary appliance 100 optionally includes a removable magnetic disk and/or a removable optical disk; further, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROM), and the like, may also be used in the exemplary appliance 100.

In accordance with the exemplary computing environment, a number of software 300 program modules (e.g., software blocks 304-340) may be stored on the hard disk, magnetic disk, optical disk, ROM or RAM, including an operating system (e.g., OS block 336), one or more application programs (e.g., blocks 304-332), other miscellaneous software program modules (e.g., misc. software block 340), and program data. A user may enter commands and information into an exemplary computing environment through input devices such as, but not limited to, a keyboard and/or a pointing device. Other input devices may include a microphone, joystick, game pad, satellite dish, scanner, or the like. These and other input devices are often connected to an exemplary appliance through a serial port interface (e.g., EIA RS I/O(s) block 232) that is coupled to the bus, but may be connected by other interfaces, such as a parallel port, game port or a universal serial bus (USB).

The exemplary appliance 100 may exist in a networked environment using logical connections to one or more remote computers; in addition, the exemplary appliance 100 may include an appliance intranet between various processor-based devices (e.g., units 120, 140, 160 and 180 of FIG. 1). A remote computer or a processor-based device may be a personal computer, a server, a router, a network PC, a peer device or other common network node. The logical connections optionally include a local area network (LAN) and a wide area network (WAN). Such networking environments are commonplace in offices, enterprise-wide Computer networks, intranets and the Internet.

When used in a LAN networking environment, an exemplary appliance is connected to the local network through a network interface or adapter (e.g., network I/O(s) block 220). When used in a WAN networking environment, an exemplary converter typically includes a modem or other means for establishing communications over the wide area network, such as the Internet. In a networked environment, software program modules may be stored in a remote memory storage device. It will be appreciated that the network connections discussed above are exemplary and other means of establishing communication between computing environments, exemplary appliances and/or processor-based devices may be used.

Referring again to FIG. 2, the exemplary appliance 100 optionally includes one or more analog I/O blocks 212 for input and/or output of analog video signals. The one or more analog I/O blocks 212 optionally operate in conjunction with one or more analog-to-digital and/or digital-to-analog converter blocks 228 (referred to herein as an “A/D converter”). An exemplary A/D converter block 228 includes an analog-to-digital converter for receiving and converting standard or non-standard analog camera video signals to digital video data.

The exemplary appliance 100 also includes one or more serial digital interface blocks 216 (or digital serial interface), which include a digital interface for receiving and/or transmitting standard and/or non-standard digital video data. In general, a network I/O block 220 and/or a SDI/SDTI block is capable of communicating digital video data at a variety of bit rates according to standard and/or non-standard communication specifications. For example, a SDI/SDTI block 216 optionally communicates digital video data according to an SMPTE specification (e.g., SMPTE 259, 292, 304, etc.). The SMPTE 259M specification states a bit rate of approximately 270 Mbps and the SMPTE 292M specification states a bit rate of approximately 1.5 Gbps, while the SMPTE 304 specification is associated with a serial digital transport interface (“SDTI”). A network I/O block 220 optionally communicates digital video data according to a 100-Base-T specification (e.g., approximately 100 Mbps). Of course, a variety of other suitable network interfaces also exist, e.g., 100VG-AnyLAN, etc., some of which may be capable of bit rates lower or higher than approximately 100 Mbps. Analog signals and/or digital data received and/or transmitted by the exemplary appliance 100 optionally include timing, audio and/or other information related to video signals and/or data received. In addition, the exemplary appliance 100 includes a protocols block 324 to assist in complying with various transmission protocols, such as, but not limited to, those associated with the aforementioned network and/or SMPTE specifications.

The exemplary appliance 100 optionally receives monochrome (e.g., black and white) and/or polychrome (e.g., at least two component color) video analog signals and/or digital data. Polychrome video (referred to herein as color video) typically adheres to a color space specification. A variety of color space specifications exist, including, but not limited to, RGB, “Y, B-Y, R-Y”, YUV, YPbPr and YCbCr, which are typically divided into analog and digital specifications. For example, YCbCr is associated with digital specifications (e.g., CCIR 601 and 656) while YPbPr is associated with analog specifications (e.g., EIA-770.2-a, CCIR 709, SMPTE 240M, etc.). The YCbCr color space specification has been described generally as a digitized version of the analog YUV and YPbPr color space specifications; however, others note that CbCr is distinguished from PbPr because in the latter the luma and chroma excursions are identical while in the former they are not. The CCIR 601 recommendation specifies an YCbCr color space with a 4:2:2 sampling format for two-to-one horizontal subsampling of Cb and Cr, to achieve approximately ⅔ the data rate of a typical RGB color space specification. In addition, the CCIR 601 recommendation also specifies that: 4:2:2 means 2:1 horizontal downsampling, no vertical downsampling (4 Y samples for every 2 Cb and 2 Cr samples in a scanline); 4:1:1 typically means 4:1 horizontal downsampling, no vertical downsampling (4 Y samples for every 1 Cb and 1 Cr samples in a scanline); and 4:2:0 means 2:1 horizontal and 2:1 vertical downsampling (4 Y samples for every Cb and Cr samples in a scanline.). The CCIR 709 recommendation includes an YPbPr color space for analog HDTV signals while the YUV color space specification is typically used as a scaled color space in composite NTSC, PAL or S-Video. Overall, color spaces such as YPbPr, YCbCr, PhotoYCC and YUV are mostly scaled versions of “Y, B-Y, R-Y” that place extrema of color difference channels at more convenient values.

As mentioned, reception of analog signals and/or digital data in non-standard color specifications is also optionally possible. Further, reception of color signals according to a yellow, green, magenta, and cyan color specification is also optionally possible. Some video cameras that rely on the use of a CCD (or CCDs) output analog signals containing luminance and color difference information. For example, one particular scheme uses a CCD that outputs raw signals corresponding to yellow (Ye), green (G), magenta (Mg) and cyan (Cy). A sample and hold circuit associated with the CCD typically derives two raw analog signals (e.g., S₁ and S₂). Other circuits associated with the CCD typically include an amplifier (or preamplifier), a correlated double sampling (CDS) circuit, and an automatic gain controller (AGC). Once the raw analog signals S₁ and S₂ have been derived, a process known as color separation is used to convert the raw analog signals, which are typically pixel pairs, to luminance and color difference. Accordingly, a luminance may equal (Mg+Ye)+(G+Cy), which corresponds to Y₀₁; a blue component may equal (Ye+G)+(Cy+Mg), which corresponds to C₀; and a red component may equal (Mg+Y2)−(G+Cy), which corresponds to C₁. The luminance Y₀₁ and chrominance signals C₀ and C₁ can be further processed to determine: R, G; and B; R-Y and B-Y; and a variety of other signals and/or data according to a variety of color specifications.

In general, an exemplary A/D converter suitable for use in the A/D converter block 228 converts each analog signal to digital data having a particular bit depth. For example, commonly used bit-depths include, but are not limited to, 8 bits, 10 bits, and 12 bits; thus, corresponding RGB digital data would have overall bit-depths of 24 bits, 30 bits and 36 bits, respectively.

Referring again to FIG. 2, the exemplary appliance 100 also optionally includes one or more digital signal processing (DSP) blocks 304 for structuring digital data. While the DSP block 304 is shown separate from the encoder block 308 and the decoder block 312, an encoder block 308 and/or a decoder block 312 optionally includes a DSP block, such as the DSP block 304. In general, DSP structures digital video data, for example, a DSP block 304 optionally structures digital video data to a digital video format suitable for encoding or compressing by an encoder block 308; to a digital video format suitable for communication through a SDI/SDTI block 216 and/or a network I/O block 220; and/or to a digital video format suitable for storage in the storage block 224, e.g., as a file or files. A DSP block 304 may also include a scaler for scaling digital video data; note that scaling of analog video data is optionally possible in an A/D converter block 228. A DSP block 304 may scale digital video data prior to and/or after structuring. In general, scaling is performed to typically reduce video resolution, color bit depth, and/or color sampling format. A DSP block may also include digital filtering algorithms.

As shown in FIG. 2, the exemplary appliance 100 includes one or more encoder blocks 308. An encoder block 308 includes a compression algorithm suitable for compressing digital video data and/or digital audio data. In general, compressed digital video data has a format suitable for communication through a SDI/SDTI block 216, a network I/O block 220 and/or other interface; and/or for storage in the storage block 224, e.g., as a file or files. Exemplary encoder schemes using various compression algorithms are discussed in more detail further below.

The exemplary appliance 100 also includes one or more decoder blocks 312. A decoder block 312 includes a decompression algorithm suitable for decompressing digital video data and/or digital audio data. In general, decompressed digital video data has a format suitable for communication through a SDI/SDTI block 216, a network I/O block 220 and/or other interface; and/or for storage in the storage block 224, e.g., as a file or files or can be processed to such a format. Exemplary decoder schemes using various decompression algorithms are discussed in more detail further below. In general, a decompression algorithm is associated with a corresponding compression algorithm. Thus, given a compression algorithm, a decompression algorithm is typically implied.

Referring again to FIG. 2, the exemplary appliance 100 optionally includes a digital rights management (DRM) block 316 for management of rights in any information received and/or transmitted. For example, video received by the exemplary appliance 100 may include copyrights, in addition, video transmitted by the exemplary appliance 100 may include new or additional copyrights. Of course, the DRM block 316 may assist in management of other rights.

The exemplary appliance 100 also includes a controller block 320 for performing various control operations, as discussed in more detail below. The exemplary appliance 100 further includes one or more browsers 328 and/or runtime engines (RE) 332. In object-oriented programming, the terms “Virtual Machine” (VM) and “Runtime Engine” (RE) have recently become associated with software that executes code on a processor or a hardware platform. In the description presented herein, the term “RE” includes VM. A RE often forms part of a larger system or framework that allows a programmer to develop an application for a variety of users in a platform independent manner. For a programmer, the application development process usually involves selecting a framework, coding in an object-oriented programming language associated with that framework, and compiling the code using framework capabilities. The resulting typically platform-independent, compiled code is then made available to users, usually as an executable file and typically in a binary format. Upon receipt of an executable file, a user can execute the application on a RE associated with the selected framework. As discussed herein, an application (e.g., in the form of compiled code) is optionally provided from and/or to various units and executed one or more of such units using a RE associated with the selected framework. In general, a RE (e.g., RE block 332) interprets and/or compiles and executes native machine code/instructions to implement an application or applications embodied in a bytecode and/or an intermediate language code (e.g., an IL code). Further, as discussed herein, a controller optionally serves code to devices not directly associated with an exemplary appliance, such as, but not limited to, a camera, a telecine, a display, etc.

Referring again to FIG. 2, a browser 328 and a RE 332 optionally operate in a coordinated manner. As discussed in more detail below, a controller block 320 operating in a controller unit (e.g., controller unit 180 of FIG. 1) optionally includes a browser for facilitating control of various other units (e.g., units 120, 140, 160, etc.) which optionally include one or more REs.

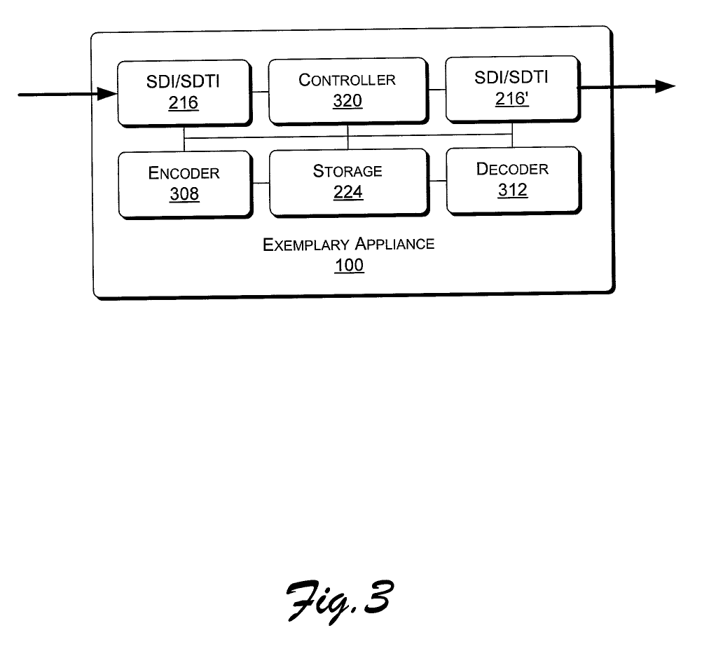

Referring to FIG. 3, a high level block diagram of an exemplary appliance 100 is shown. Note that this exemplary appliance 100 includes features of an encoder unit (encoder block 308), a decoder unit (decoder block 312), a server unit (storage block 224), and a controller unit (controller block 320); the SDI/SDTI blocks 216, 216′ may be associated with any of these particular units. Accordingly this exemplary appliance 100 is configured to receive digital video data via the SDI/SDTI block 216 and transmit digital video data via the other SDI/SDTI block 216′. The controller block 320 controls operation of the exemplary appliance 100, via one or more communication links (shown as connecting lines), through control of the SDI/SDTI block 216, 216′, the encoder block 308, the decoder block 312, and the storage block 224. For example, the exemplary appliance 100 may receive digital video data according to a SMPTE specification via the SDI/SDTI block 216. The controller block 320 may then direct the digital video data via a communication link to the encoder block 308. The encoder block 308 optionally includes a DSP block to structure the digital video data, particularly if structuring is necessary prior to encoding or compressing the digital video data. In this exemplary appliance 100, the encoder block 308 either structures the digital video data or structures and compresses the digital data. In the former instance, the digital video data is suitable for transmission to the storage block 224, the decoder block 312 and/or the SDI/SDTI transmission block 216′ as uncompressed data while in the latter instance, the digital video data is suitable for transmission to the storage block 224, the decoder block 312 and/or the SDI/SDTI transmission block 216′ as compressed data. As such, the decoder block 312 receives digital video data from the encoder block 308 and/or the storage block 224. Once received, the decoder block 312 can structure and/or decode or decompress the digital video data. In general, digital video data output from the decoder block 312 is suitable for transmission via the SDI/SDTI block 216′ and/or storage in the storage block 224.

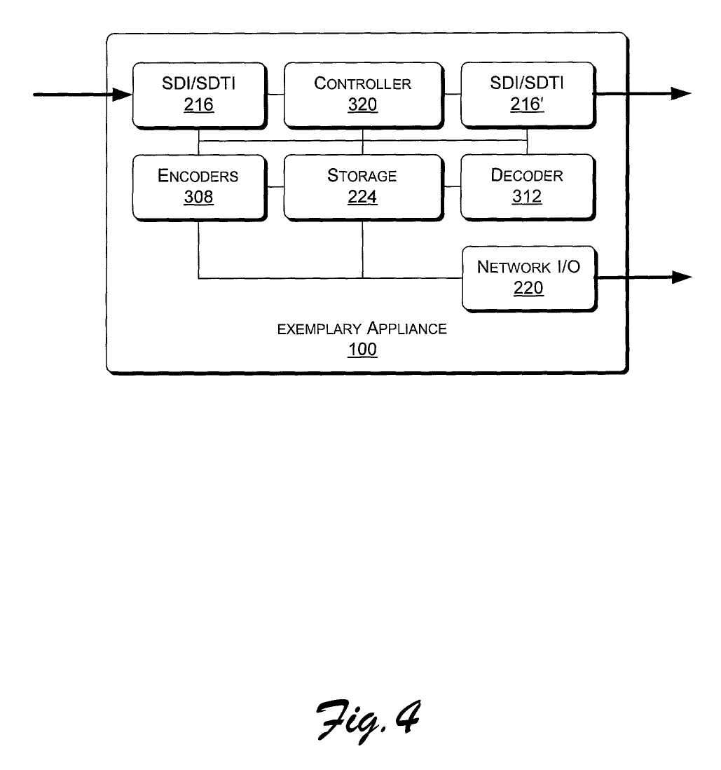

Referring to FIG. 4, the exemplary appliance 100 of FIG. 3 is shown together with a network I/O block 220. Accordingly, the exemplary appliance of FIG. 4 is capable of transmitting digital video data via a SDI/SDTI block 216′ and/or the network I/O block 220. In addition, characteristics of digital video data transmitted to the SDI/SDTI block 216′ and the network I/O block 220 may differ even though the digital video originated from the same source, e.g., received via the SDI/SDTI block 216. For example, the SDI/SDTI block 216′ may receive from the encoder block 308, the storage block 224 or the decoder block 312, uncompressed digital video data for transmission at a first bit rate while the network I/O block 220 may receive from the encoder block 312, the storage block 224 or decoder block 312, compressed digital video data for transmission at a second bit rate. In general, bit rates for such uncompressed and compressed will differ wherein the first bit rate associated with the uncompressed data is greater than the second bit rate associated with the compressed data. While not shown in FIG. 4, in yet another exemplary appliance, additional SDI/SDTI blocks and/or network I/O blocks are included to facilitate transmission of a digital video data having a variety of characteristics.

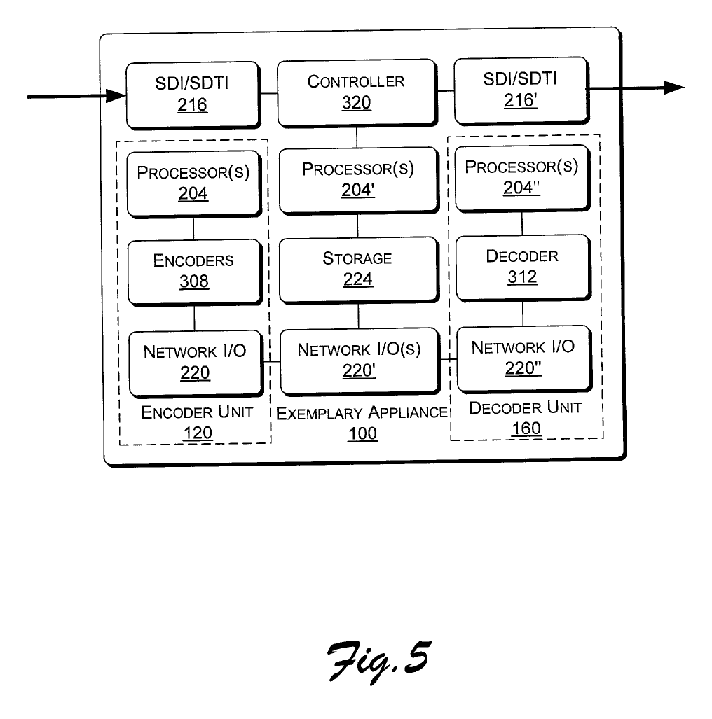

Referring to FIG. 5, a block diagram of another exemplary appliance 100 is shown. This particular appliance 100 includes an intranet, as explained below. The exemplary appliance 100 of FIG. 5 includes many of the features of the exemplary appliance 100 of FIG. 3; however, in FIG. 5, three separate processors or groups of processors (e.g., 204, 204′, 204″) and three separate network I/Os or group of network I/Os (e.g., 220, 220′, 220″) are shown along with boundaries around an encoder unit 120 and a decoder unit 160. The three separate network I/Os form an intranet within the exemplary appliance 100. In this particular exemplary appliance 100, the server unit and controller unit operate on the same process-based device and include two or more SDI/SDTI blocks 216, 216′, one or more processor blocks 204′, a storage block 224, and one or more network I/O blocks 220′; thus, forming at least one node on the intranet. The encoder unit 120 and the decoder unit 160 form two or more additional nodes on the appliance intranet. The encoder unit 120 includes one or more processor blocks 204 and a network I/O block 220 and the decoder unit 160 includes one or more processor blocks 204 and a network I/O block 220. According to this exemplary appliance 100, the controller block 320 controls the encoder unit 120 and the decoder unit 160 via the one or more network I/O blocks 220′. In addition, digital video data received via the SDI/SDTI block 216 and/or stored in the storage block 224 is communicable via the network I/O blocks 220, 220′, 220″.

In general, the intranet of the exemplary appliance 100 of FIG. 5 is a network wherein nodes interact and are identifiable using addresses (e.g., IP, HTTP, etc.). Further, files within the exemplary appliance 100 are optionally identifiable by universal resource locators (URLs) and data being exchanged between units are typically formatted using a language such as HTML, XML, etc. A browser is optionally included within the controller unit and/or other unit(s) to facilitate management and/or control of the exemplary appliance 100 and optionally other devices. In addition, the intranet of the exemplary appliance 100 of FIG. 5 is optionally connected to one or more larger networks (e.g., the Internet, etc.). Of course, one or more firewalls and/or gateway computers may exist between the intranet and a larger network.

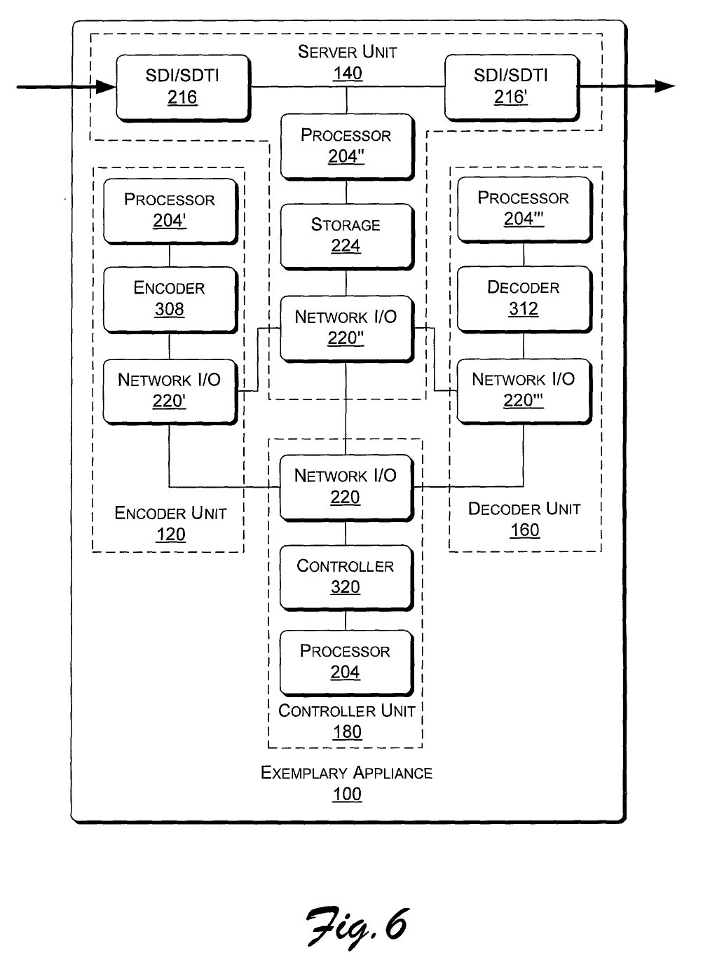

Referring to FIG. 6, a block diagram of yet another exemplary appliance 100 is shown. This particular appliance 100 includes some of the features of the appliance 100 of FIG. 5; however, in FIG. 6, four separate processors or groups of processors (e.g., 204, 204′, 204″, 204′″) and four separate network I/Os or group of network I/Os (e.g., 220, 220′, 220″, 220′″) are shown along with boundaries around an encoder unit 120, a decoder unit 160, a server unit 140 and a controller unit 180. The four separate units form an intranet within the exemplary appliance 100. In this particular exemplary appliance 100, the encoder unit 120, the server unit 140, the decoder unit 160 and the controller unit 180 operate on separate process-based devices; thus, forming at least four nodes on the intranet. The server unit 140 includes one or more processor blocks 204″ and one or more network I/O blocks 220″ while the controller unit 180 includes one or more processor blocks 204 and one or more network I/O blocks 220. According to this exemplary appliance 100, the controller unit 180 controls the encoder unit 120, the server unit 140 and the decoder unit 160 via the one or more network I/O blocks 220. In addition, digital video data received via the SDI/SDTI block 216 and/or stored in the storage block 224 is communicable via the network I/O blocks 220, 220′, 220″, 220′″.

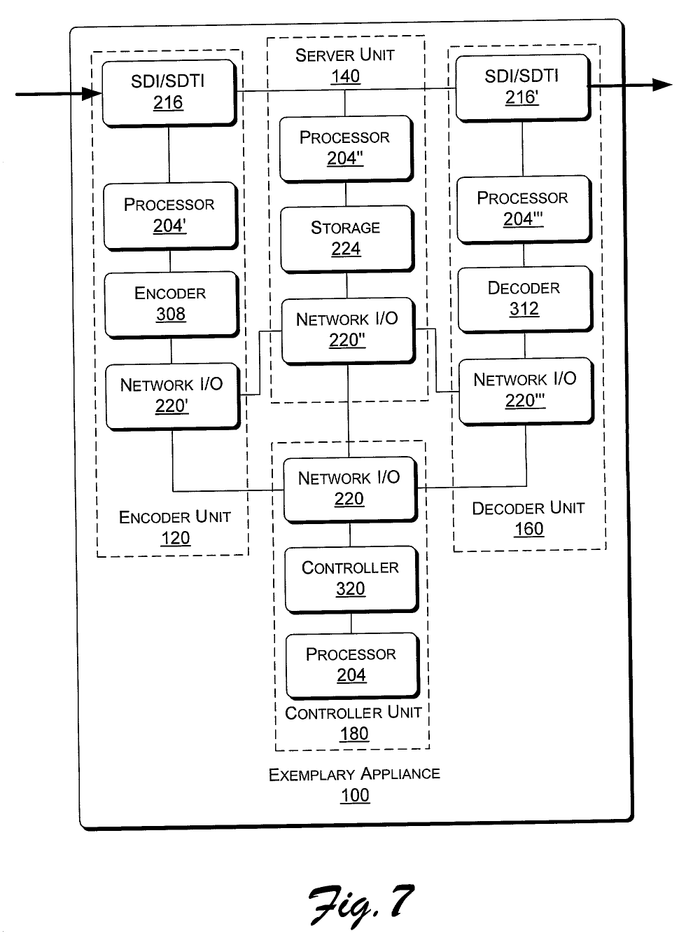

Referring to FIG. 7, a block diagram of an exemplary appliance 100 is shown. The appliance 100 of FIG. 7 includes many features of the exemplary appliance 100 of FIG. 6; however, additional communication links exist between the SDI/SDTI blocks 216, 216′ and the encoder unit 120 and the decoder unit 160. These particular communication links provide an alternative to transfer of digital video data via a network I/O. For example, according to the exemplary appliance 100, digital video data received via SDI/SDTI block 216 is operably transmittable via instructions executed by the processor block 204′ of the encoder unit 120 and/or via instructions executed by the processor block 204″ of the server unit 140. While the exemplary appliance 100 of FIG. 7, when compared to the exemplary appliance 100 of FIG. 6, includes additional communication links and a different placement of SDI/SDTI blocks within the appliance's units, the controller unit 180 still maintains control through use of network I/O blocks (e.g., 220, 220′, 220″, 220′″). Thus, in both the exemplary appliance 100 of FIG. 6 and the exemplary appliance of FIG. 7, an intranet provides communication links for control via the controller unit 180.

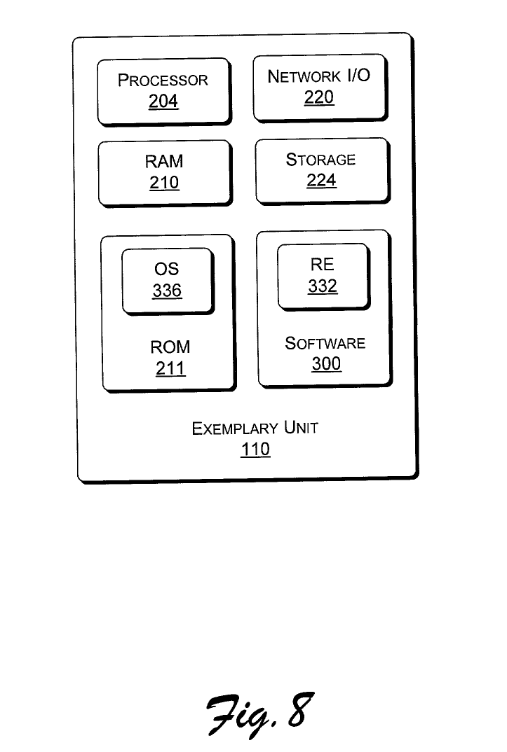

FIG. 8 shows a block diagram of an exemplary unit 110. This exemplary unit 110 is suitable for use as an encoder unit, a decoder unit, a server unit and/or a controller unit and is suitable for use in an intranet or internet. The exemplary unit 110 includes a processor block 204, a RAM block 210, a ROM block 211, a network I/O block 220, a storage block 224, and a software block 300, which includes a RE block 332. The exemplary unit 110 includes features suitable for support of .NET™ framework applications (Microsoft Corporation, Redmond, Wash.) and/or other framework applications. Exemplary appliances (e.g., such as the exemplary appliance 100 of FIG. 7) that have units (e.g., such as the exemplary unit 110 of FIG. 8), which are capable of operating with a framework, are generally extensible and flexible. For example, such an appliance is characterized by a ready capability to adapt to new, different, and/or changing requirements and by a ready capability to increase scope and/or application.

In general, as already mentioned, a RE is often associated with a particular framework. Further, a framework has associated classes which are typically organized in class libraries. Classes can provide functionality such as, but not limited to, input/output, string manipulation, security management, network communications, thread management, text management, and other functions as needed. Data classes optionally support persistent data management and optionally include SQL classes for manipulating persistent data stores through a standard SQL interface. Other classes optionally include XML classes that enable XML data manipulation and XML searching and translations. Often a class library includes classes that facilitate development and/or execution of one or more user interfaces (UIs) and, in particular, one or more graphical user interfaces (GUIs).

As described herein, the RE block 322 of the exemplary unit 110 optionally acts as an interface between applications and the OS block 336. Such an arrangement can allow applications to use the OS advantageously within any particular unit.

Various aforementioned exemplary appliances, and/or variations thereof, optionally include features such as those described below. Such features include, for example, encoders, decoders, formats, hardware, software, communication links, computing and/or network environments, data architectures, etc.

Exemplary Encoders, Decoders and/or File Formats

As discussed herein, exemplary appliances include one or more encoder block. Further, as already mentioned, an encoder block optionally includes a DSP block capable of structuring digital data. Of course, a server unit may include a DSP block capable of structuring digital data. According to an exemplary method, structuring optionally involves structuring some or all of the digital video data to a group or a series of individual digital image files on a frame-by-frame and/or other suitable basis. Of course, in an alternative, not every frame is converted. Note that an analog-to-digital conversion may also optionally perform such tasks. According to an exemplary structuring process, a DSP block structures a frame of digital video data to a digital image file and/or frames of digital video data to a digital video file. Suitable digital image file formats include, but are not limited to, the tag image file format (TIFF), which is a common format for exchanging raster graphics (bitmap) images between application programs. The TIFF format is capable of describing bilevel, grayscale, palette-color, and full-color image data in several color spaces. In addition, TIFF format files may be structured to an audio video interleaved (AVI) format file, which is suitable for storage in a storage block and/or compression by an encoder block. Of course, a DSP block may structure digital data directly to an AVI format and/or structure digital data directly or indirectly to a WINDOWS MEDIA™ format. In addition, use of a QUICKTIME® (Apple Computer, Inc., Cupertino, Calif.) format is also possible, for example, for storage, input and/or output. Further details of formats are discussed below.

As described above with reference to various exemplary appliances and/or methods, an encoder or an encode block can provide for compression of digital video data. Algorithmic processes for compression generally fall into two categories: lossy and lossless. For example, algorithms based on the discrete cosine transform (DCT) are lossy whereas lossless algorithms are not DCT-based. A baseline JPEG lossy process, which is typical of many DCT-based processes, involves encoding by: (i) dividing each component of an input image into 8×8 blocks; (ii) performing a two-dimensional DCT on each block; (iii) quantizing each DCT coefficient uniformly; (iv) subtracting the quantized DC coefficient from the corresponding term in the previous block; and (v) entropy coding the quantized coefficients using variable length codes (VLCs). Decoding is performed by inverting each of the encoder operations in the reverse order. For example, decoding involves: (i) entropy decoding; (ii) performing a 1-D DC prediction; (iii) performing an inverse quantization; (iv) performing an inverse DCT transform on 8×8 blocks; and (v) reconstructing the image based on the 8×8 blocks. While the process is not limited to 8×8 blocks, square blocks of dimension 2ⁿ×2ⁿ, where “n” is an integer, are preferred. A particular JPEG lossless coding process uses a spatial-prediction algorithm based on a two-dimensional differential pulse code modulation (DPCM) technique. The TIFF format supports a lossless Huffman coding process.

The TIFF specification also includes YCrCb, CMYK, RGB, CIE L*a*b* color space specifications. Data for a single image may be striped or tiled. A combination of strip-orientated and tile-orientated image data, while potentially possible, is not recommended by the TIFF specification. In general, a high resolution image can be accessed more efficiently—and compression tends to work better—if the image is broken into roughly square tiles instead of horizontally-wide but vertically-narrow strips. Data for multiple images may also be tiled and/or striped in a TIFF format; thus, a single TIFF format file may Contain data for a plurality of images. In addition, TIFF format files are convertible to an AVI format file.

The AVI file format is a file format for digital video and audio for use with WINDOWS® OSs and/or other OSs. According to the AVI format, blocks of video and audio data are interspersed together. Although an AVI format file can have “n” number of streams, the most common case is one video stream and one audio stream. The stream format headers define the format (including compression) of each stream.

Referring again to FIGS. 1 through 7, a function of the encoder blocks is to compress digital video data. An encoder or encoding process can produce compressed digital video data in a particular format. Accordingly, an exemplary appliance may store compressed and/or uncompressed digital video data in a file or files and/or stream digital video data via a communication interface. One suitable, non-limiting format is the WINDOWS MEDIA™ format, which is a format capable of use in, for example, streaming audio, video and text from a server to a client computer, or, in general, via a network. Of course, a WINDOWS MEDIA™ format file may also be stored locally within an appliance. In general, a format may include more than just a file format and/or stream format specification. For example, a format may include codecs. Consider, as an example, the WINDOWS MEDIA™ format, which comprises audio and video codecs, an optional integrated digital rights management (DRM) system, a file container, etc. As referred to herein, a WINDOWS MEDIA™ format file and/or WINDOWS MEDIA™ format stream have characteristics of files suitable for use as a WINDOWS MEDIA™ format container file. Details of such characteristics are described below. In general, the term “format” as used for files and/or streams refers to characteristics of a file and/or a stream and not necessarily characteristics of codecs, DRM, etc. Note, however, that a format for a file and/or a stream may include specifications for inclusion of information related to codec, DRM, etc.

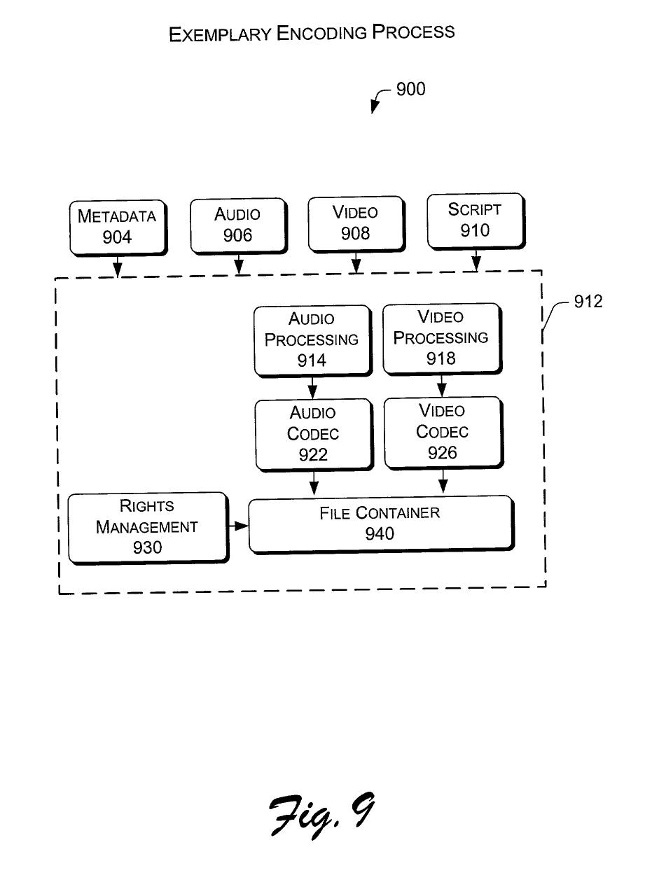

A block diagram of an exemplary encoding process for encoding digital data to a particular format 900 is shown in FIG. 9. Referring to FIG. 9, in the exemplary encoding process 900, an encoding block 912 accepts information from a metadata block 904, an audio block 906, a video block 908, and/or a script block 910. The information is optionally contained in an AVI format file and/or in a stream; however, the information may also be in an uncompressed WINDOWS MEDIA™ format or other suitable format. In an audio processing block 914 and in a video processing block 918, the encoding block 912 performs audio and/or video processing. Next, in an audio codec block 922 and in a video codec block 926, the encoding block 912 compresses the processed audio, video and/or other information and outputs the compressed information to a file container 940. Before, during and/or after processing and/or compression, a rights management block 930 optionally imparts information to the file container block 940 wherein the information is germane to any associated rights, e.g., copyrights, trademark rights, patent, etc., of the process or the accepted information.

The file container block 940 typically stores file information as a single file. Of course, information may be streamed in a suitable format rather than specifically “stored”. An exemplary, non-limiting file and/or stream has a WINDOWS MEDIA™ format. The term “WINDOWS MEDIA™ format”, as used throughout, includes the active stream format and/or the advanced systems format, which are typically specified for use as a file container format. The active stream format and/or advanced systems format may include audio, video, metadata, index commands and/or script commands (e.g., URLs, closed captioning, etc.). In general, information stored in a WINDOWS MEDIA™ file container, will be stored in a file having a file extension such as .wma, .wmv, or .asf; streamed information may optionally use a same or a similar extension(s).

In general, a file (e.g., according to a file container specification) contains data for one or more streams that can form a multimedia presentation. Stream delivery is typically synchronized to a common timeline. A file and/or stream may also include a script, e.g., a caption, a URL, and/or a custom script command. As shown in FIG. 9, the encoding process 900 uses at least one codec or compression algorithm to produce a file and/or at least one data stream. In particular, such a process may use a video codec or compression algorithm and/or an audio codec or compression algorithm. Furthermore, an encoder block, encoding block, decoder block and/or decoding block optionally support structuring, compression and/or decompression processes that can utilize a plurality of processors, for example, to enhance structuring, compression, decompression, and/or execution speed of a file and/or a data stream.

One suitable video compression and/or decompression algorithm (or codec) is entitled MPEG-4 v3, which was originally designed for distribution of video over low bandwidth networks using high compression ratios (e.g., see also MPEG-4 v2 defined in ISO MPEG-4 document N3056). The MPEG-4 v3 decoder uses post processors to remove “blockiness”, which improves overall video quality, and supports a wide range of bit rates from as low as 10 kbps (e.g., for modem users) to 10 Mbps or more. Another suitable video codec uses block-based motion predictive coding to reduce temporal redundancy and transform coding to reduce spatial redundancy.

A suitable conversion software package that uses codecs is entitled WINDOWS MEDIA™ Encoder. The WINDOWS MEDIA™ Encoder software can compress live or stored audio and/or video content into WINDOWS MEDIA™ format files and/or data streams (e.g., such as the process 900 shown in FIG. 9). This software package is also available in the form of a software development kit (SDK). The WINDOWS MEDIA™ Encoder SDK is one of the main components of the WINDOWS MEDIA™ SDK. Other components include the WINDOWS MEDIA™ Services SDK, the WINDOWS MEDIA™ Format SDK, the WINDOWS MEDIA™ Rights Manager SDK, and the WINDOWS MEDIA™ Player SDK.

The WINDOWS MEDIA™ Encoder 7.1 software optionally uses an audio codec entitled WINDOWS MEDIA™ Audio 8 (e.g., for use in the audio codec block 922) and a video codec entitled WINDOWS MEDIA™ Video 8 codec (e.g., for use in the video codec block 926). The Video 8 codec uses block-based motion predictive coding to reduce temporal redundancy and transform coding to reduce spatial redundancy. Of course, later codecs (e.g., Video 9 and Audio 9, etc.) are also suitable. These aforementioned codecs are suitable for use in real-time Capture and/or streaming applications as well as non-real-time applications, depending on demands. In a typical application, WINDOWS MEDIA™ Encoder 7.1 software uses these codecs to compress data for storage and/or streaming, while WINDOWS MEDIA™ Player software decompresses the data for playback. Often, a file or a stream compressed with a particular codec or codecs may be decompressed or played back using any of a variety of player software. In general, the player software requires knowledge of a file or a stream compression codec.

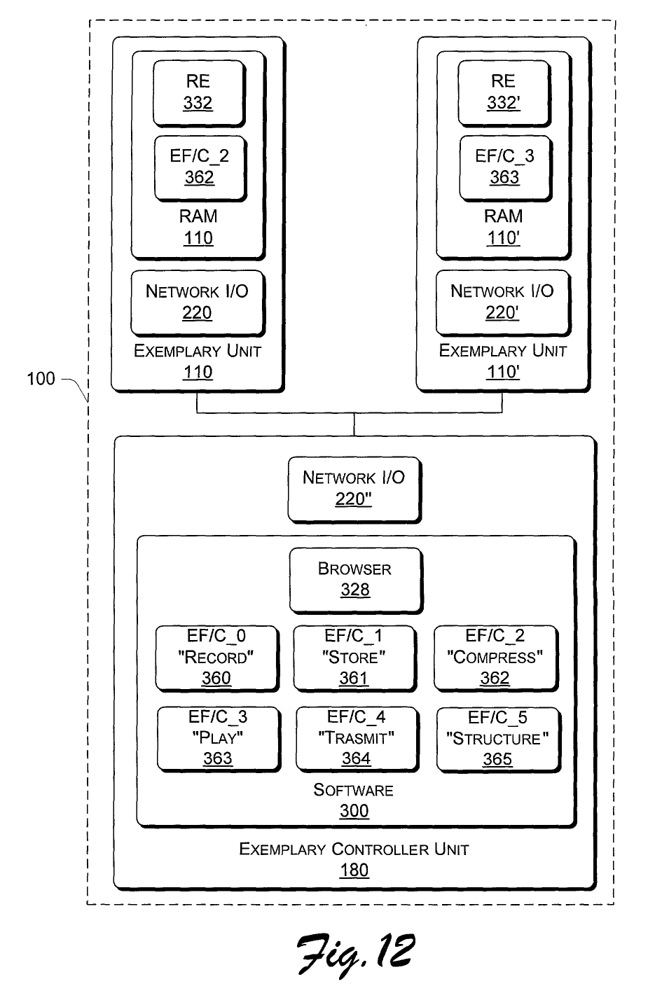

The Audio 8 codec is capable of producing a WINDOWS MEDIA™ format audio file of the same quality as a MPEG-1 audio layer-3 (MP3) format audio file, but at less than approximately one-half the size. While the quality of encoded video depends on the content being encoded, for a resolution of 640 pixel by 480 line, a frame rate of 24 fps and 24 bit depth color, the Video 8 codec is capable of producing 1:1 (real-time) encoded content in a WINDOWS MEDIA™ format using a processor-based device having a processor speed of approximately 1 GHz. The same approximately 1 GHz device would encode video having a resolution of 1280 pixel by 720 line, a frame rate of 24 fps and 24 bit depth color in a ratio of approximately 6:1 and a resolution of 1920 pixel by 1080 line, a frame rate of 24 fps and 24 bit depth color in a ratio of approximately 12:1 (see also the graph of FIG. 12 and the accompanying description). Essentially, the encoding process in these examples is processor speed limited. Thus, an approximately 6 GHz processor can encode video having a resolution of 1280 pixel by 720 line, a frame rate of 24 fps and 24 bit depth color in real-time; likewise, an approximately 12 GHz processor can encode video having a resolution of 1920 pixel by 1080 line, a frame rate of 24 fps and 24 bit depth color in real-time. Overall, the Video 8 codec and functional equivalents thereof are suitable for use in encoding, decoding, streaming and/or downloading digital data. Of course, according to various exemplary methods, devices, systems and/or storage media described herein, video codecs other than the Video 8 may be used.

The WINDOWS MEDIA™ Encoder 7.1 supports single-bit-rate (or constant) streams and/or variable-bit-rate (or multiple-bit-rate) streams. Single-bit-rates and variable-bit-rates are suitable for some real-time capture and/or streaming of audio and video content and support of a variety of connection types, for example, but not limited to, 56 kbps over a dial-up modem and 500 kbps over a cable modem or DSL line. Of course, other higher bandwidth connections types are also supported and/or supportable. Thus, support exists for video profiles (generally assuming a 24 bit color depth) such as, but not limited to, DSL/cable delivery at 250 kbps, 320×240, 30 fps and 500 kbps, 320×240, 30 fps; LAN delivery at 100 kbps, 240×180, 15 fps; and modem delivery at 56 kbps, 160×120, 15 fps. The exemplary Video 8 and Audio 8 codecs are suitable for supporting such profiles wherein the compression ratio for video is generally at least approximately 50:1 and more generally in the range of approximately 200:1 approximately 500:1 (of course, higher ratios and/or lower ratios are also possible). For example, video having a resolution of 320 pixel by 240 line, a frame rate of 30 fps and a color depth of 24 bits requires approximately 55 Mbps; thus, for DSL/cable delivery at 250 kbps, a compression ratio of at least approximately 220:1 is required. Consider another example, a 1280×720, 24 fps profile at a color bit depth of 24 corresponds to a rate of approximately 0.53 Gbps. Compression of approximately 500:1 reduces this rate to approximately 1 Mbps. Of course, compression may be adjusted to target a specific rate or range of rates, e.g., 0.1 Mbps, 0.5 Mbps, 1.5 Mbps, 3 Mbps, 4.5 Mbps, 6 Mbps, 10 Mbps, 20 Mbps, etc. In addition, where bandwidth allows, compression ratios less than approximately 200:1 may be used, for example, compression ratios of approximately 30:1 or approximately 50:1 may be suitable. Of course, while an approximately 2 Mbps data rate is available over many LANs, even a higher speed LAN may require further compression to facilitate distribution to a plurality of users (e.g., at approximately the same time). Again, while these examples refer to the Video 8 and/or Audio 8 codecs, use of other codecs is also possible.

The Video 8 and Audio 8 codecs, when used with the WINDOWS MEDIA™ Encoder 7.1 may be used for capture, structuring, compression, decompression, storage and/or streaming of audio and video content in a WINDOWS MEDIA™ format. Conversion of an existing video file(s) (e.g., AVI format files) to the WINDOWS MEDIA™ file format is possible with WINDOWS MEDIA™ 8 Encoding Utility software. The WINDOWS MEDIA™ 8 Encoding Utility software supports “two-pass” and variable-bit-rate encoding. The WINDOWS MEDIA™ 8 Encoding Utility software is suitable for producing content in a WINDOWS MEDIA™ format that can be downloaded and played locally.

As already mentioned, the WINDOWS MEDIA™ format optionally includes the active stream format and/or the advanced systems format. Various features of the active stream format are described in U.S. Pat. No. 6,041,345, entitled “Active stream format for holding multiple media streams”, issued Mar. 21, 2000, and assigned to Microsoft Corporation ('345 patent). The '345 patent is incorporated herein by reference for all purposes, particularly those related to file formats and/or stream formats. The '345 patent defines an active stream format for a logical structure that optionally encapsulates multiple data streams, wherein the data streams may be of different media (e.g., audio, video, etc.). The data of the data streams is generally partitioned into packets that are suitable for transmission over a transport medium (e.g., a network, etc.). The packets may include error correcting information. The packets may also include clock licenses for dictating the advancement of a clock when the data streams are rendered. The active stream format can facilitate flexibility and choice of packet size and bit rate at which data may be rendered. Error concealment strategies may be employed in the packetization of data to distribute portions of samples to multiple packets. Property information may also be replicated and stored in separate packets to enhance error tolerance.

In general, the advanced systems format is a file format used by WINDOWS MEDIA™ technologies and it is generally an extensible format suitable for use in authoring, editing, archiving, distributing, streaming, playing, referencing and/or otherwise manipulating content (e.g., audio, video, etc.). Thus, it is suitable for data delivery over a wide variety of networks and is also suitable for local playback. In addition, it is suitable for use with a transportable storage medium (e.g., a DVD disk, CD disk, etc.). As mentioned, a file container (e.g., the file container 940) optionally uses an advanced systems format, for example, to store any of the following: audio, video, metadata (such as the file's title and author), and index and script commands (such as URLs and closed captioning); which are optionally stored in a single file. Various features of the advanced systems format appear in a document entitled “Advanced Systems Format (ASF)” from Microsoft Corporation (Doc. Rev. 01.13.00e—current as of 01.23.02). This document is a specification for the advanced systems format and is available through the Microsoft Corporation Web site (www.microsoft.com). The “Advanced Systems Format (ASF)” document (sometimes referred to herein as the “ASF specification”) is incorporated herein by reference for all purposes and, in particular, purposes relating to encoding, decoding, file formats and/or stream formats.

An ASF file typically includes three top-level objects: a header object, a data object, and an index object. The header object is commonly placed at the beginning of an ASF file; the data object typically follows the header object; and the index object is optional, but it is useful in providing time-based random access into ASF files. The header object generally provides a byte sequence at the beginning of an ASF file (e.g., a GUID to identify objects and/or entities within an ASF file) and contains information to interpret information within the data object. The header object optionally contains metadata, such as, but not limited to, bibliographic information, etc.

An ASF file and/or stream may include information such as, but not limited to, the following: format data size (e.g., number of bytes stored in a format data field); image width (e.g., width of an encoded image in pixels); image height (e.g., height of an encoded image in pixels); bits per pixel; compression ID (e.g., type of compression); image size (e.g., size of an image in bytes); horizontal pixels per meter (e.g., horizontal resolution of a target device for a bitmap in pixels per meter); vertical pixels per meter (e.g., vertical resolution of a target device for a bitmap in pixels per meter); colors used (e.g., number of color indexes in a color table that are actually used by a bitmap); important colors (e.g., number of color indexes for displaying a bitmap); codec specific data (e.g., an array of codec specific data bytes).

The ASF also allows for inclusion of commonly used media types, which may adhere to other specifications. In addition, a partially downloaded ASF file may still function (e.g., be playable), as long as required header information and some complete set of data are available.

A computing environment of a video appliance typically includes use of one or more multimedia file formats. As already mentioned, the advanced systems format (ASF) is suitable for use in a computing environment. Another exemplary multimedia file format is known as the advanced authoring format (AAF), which is an industry-driven, cross-platform, multimedia file format that can allow interchange of data between AAF-compliant applications. According to the AAF specification (see, e.g., Advanced Authoring Format Developers' Guide, Version 1.0, Preliminary Draft, 1999, which is available at http://aaf.sourceforge.net), “essence” data and metadata can be interchanged between compliant applications using the AAF. As defined by the AAF specification, essence data includes audio, video, still image, graphics, text, animation, music and other forms of multimedia data while metadata includes data that provides information on how to combine or modify individual sections of essence data and/or data that provides supplementary information about essence data. Of course, as used herein, metadata may include, for example, other information pertaining to operation of units and/or components in a computing environment. Further, metadata optionally includes information pertaining to business practices, e.g., rights, distribution, pricing, etc.

The AAF includes an object specification and a software development kit (SDK). The AAF Object Specification defines a structured container for storing essence data and metadata using an object-oriented model. The AAF Object Specification defines the logical contents of the objects and the rules for how the objects relate to each other. The AAF Low-Level Container Specification describes how each object is stored on disk. The AAF Low-Level Container Specification uses Structured Storage, a file storage system, to store the objects on disk. The AAF SDK Reference Implementation is an object-oriented programming toolkit and documentation that allows applications to access data stored in an AAF file. The AAF SDK Reference Implementation is generally a platform-independent toolkit provided in source form, it is also possible to create alternative implementations that access data in an AAF file based on the information in the AAF Object Specification and the AAF Low-Level Container Specification.

The AAF SDK Reference Implementation provides an application with a programming interface using the Component Object Model (COM). COM provides mechanisms for components to optionally interact independently of how the components are implemented. The AAF SDK Reference Implementation is provided generally as a platform-independent source code. AAF also defines a base set of built-in classes that can be used to interchange a broad range of data between applications. However, for applications having additional forms of data that cannot be described by the basic set of built-in classes, AAF provides a mechanism to define new classes that allow applications to interchange data that cannot be described by the built-in classes. Overall, an AAF file and an AAF SDK implementation can allow an application to access an implementation object which, in turn, can access an object stored in an AAF file.

Accordingly, various exemplary methods, devices, and/or systems optionally implement one or more multimedia formats and/or associated software to provide some degree of interoperability. An implementation optionally occurs within an exemplary appliance at a unit level and/or at a control level. In addition, an exemplary appliance optionally operates via such an implementation in a computing environment that extends beyond the appliance.

Referring again to software to facilitate encoding and/or decoding, as already mentioned, the WINDOWS MEDIA™ 8 Encoding Utility is capable of encoding content at variable bit rates. In general, encoding at variable bit rates may help preserve image quality of the original video because the bit rate used to encode each frame can fluctuate, for example, with the complexity of the scene composition. Types of variable bit rate encoding include quality-based variable bit rate encoding and bit-rate-based variable bit rate encoding. Quality-based variable bit rate encoding is typically used for a set desired image quality level. In this type of encoding, content passes through the encoder once, and compression is applied as the content is encountered. This type of encoding generally assures a high encoded image quality. Bit-rate-based variable bit rate encoding is useful for a set desired bit rate. In this type of encoding, the encoder reads through the content first in order to analyze its complexity and then encodes the content in a second pass based on the first pass information. This type of encoding allows for control of output file size. As a further note, generally, a source file must be uncompressed; however, compressed (e.g., AVI format) files are supported if an image compression manager (ICM) decompressor software is used.

Use of the Video 8 codec (or essentially any codec) due to compression and/or decompression computations places performance demands on a computer, in particular, on a computer's processor or processors. Demand variables include, but are not limited to, resolution, frame rate and bit depth. For example, a media player relying on the Video 8 codec and executing on a processor-based device with a processor speed of approximately 0.5 GHz can decode and play encoded video (and/or audio) having a video resolution of 640 pixel by 480 line, a frame rate of approximately 24 fps and a bit depth of approximately 24. A processor-based device with a processor of approximately 1.5 GHz could decode and play encoded video (and/or audio) having a video resolution of 1280 pixel by 720 line, a frame rate of approximately 24 fps and a bit depth of approximately 24; while, a processor-based device with a processor of approximately 3 GHz could decode and play encoded video (and/or audio) having a video resolution of 1920 pixel by 1080 line, a frame rate of approximately 24 fps and a bit depth of approximately 24 (see also the graph of FIG. 12 and the accompanying description).

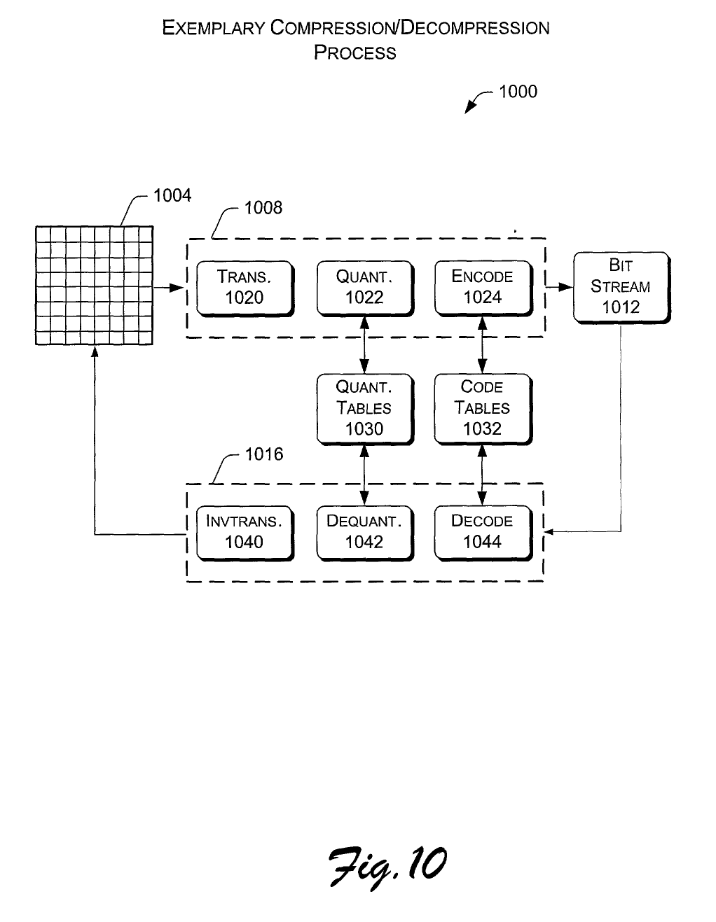

A block diagram of an exemplary compression and decompression process 1000 is shown in FIG. 10. In this exemplary compression and decompression process 1000, an 8 pixel×8 pixel image block 1004 from, for example, a frame of a 1920 pixel×1080 line image, is compressed in a compression block 1008, to produce a bit stream 1012. The bit stream 1012 is then (locally and/or remotely, e.g., after streaming to a remote site) decompressed in a decompression block 1016. Once decompressed, the 8 pixel×8 pixel image block 1004 is ready for display, for example, as a pixel by line image.

Note that the compression block 1008 and the decompression block 1016 include several internal blocks as well as a shared quantization table block 1030 and a shared code table block 1032 (e.g., optionally containing a Huffman code table or tables). These blocks are representative of compression and/or decompression process that use a DCT algorithm (as mentioned above) and/or other algorithms. For example, as shown in FIG. 10, a compression process that uses a transform algorithm generally involves performing a transform on a pixel image block in a transform block 1020, quantizing at least one transform coefficient in a quantization block 1022, and encoding quantized coefficients in a encoding block 1024; whereas, a decompression process generally involves decoding quantized coefficients in a decoding block 1044, dequantizing coefficients in a dequantization block 1042, and performing an inverse transform in an inverse transform block 1040. As mentioned, the compression block 1008 and/or the decompression block 1016 optionally include other functional blocks. For example, the compression block 1008 and the decompression block 1016 optionally include functional blocks related to image block-based motion predictive coding to reduce temporal redundancy and/or other blocks to reduce spatial redundancy. In addition, blocks may relate to data packets. Again, the WINDOWS MEDIA™ format is typically a packetized format in that a bit stream, e.g., the bit stream 1012, would contain information in a packetized form. In addition, header and/or other information are optionally included wherein the information relates to such packets, e.g., padding of packets, bit rate and/or other format information (e.g., error correction, etc.). In general, various exemplary methods for producing a digital data stream produce a bit stream such as the bit stream 1012 shown in FIG. 10.

Compression and/or decompression processes may also include other features to manage the data. For example, sometimes every frame of data is not fully compressed or encoded. According to such a process frames are typically classified, for example, as a key frame or a delta frame (also see the aforementioned “I frame”, “P frame” and “B frame”). A key frame may represent frame that is entirely encoded, e.g., similar to an encoded still image. Key frames generally occur at intervals, wherein each frame between key frames is recorded as the difference, or delta, between it and previous frames. The number of delta frames between key frames is usually determinable at encode time and can be manipulated to accommodate a variety of circumstances. Delta frames are compressed by their very nature. A delta frame contains information about image blocks that have changed as well motion vectors (e.g., bidirectional, etc.), or information about image blocks that have moved since the previous frame. Using these measurements of change, it might be more efficient to note the change in position and composition for an existing image block than to encode an entirely new one at the new location. Thus delta frames are most compressed in situations where the video is very static. As already explained, compression typically involves breaking an image into pieces and mathematically encoding the information in each piece. In addition, some compression processes optimize encoding and/or encoded information. Further, other compression algorithms use integer transforms that are optionally approximations of the DCT, such algorithms may also be suitable for use in various exemplary methods, devices, systems and/or storage media described herein. In addition, a decompression process may also include post-processing.

Exemplary I/Os for Internal and/or External Communication

As already mentioned, an exemplary encoder block and/or encoding block optionally produces a bit stream capable of carrying variable-bit-rate and/or constant-bit-rate video and/or audio data in a particular format. Again, such bit streams are often measured in terms of bandwidth and in a transmission unit of kilobits per second (kbps), millions of bits per second (Mbps) or billions of bits per second (Gbps). For example, an integrated services digital network line (ISDN) type T-1 can, at the moment, deliver up to 1.544 Mbps and a type E1 can, at the moment, deliver up to 2.048 Mbps. Broadband ISDN (BISDN) can support transmission from 2 Mbps up to much higher, but as yet unspecified, rates. Another example is known as digital subscriber line (DSL) which can, at the moment, deliver up to 8 Mbps. A variety of other examples exist, some of which can transmit at bit rates substantially higher than those mentioned herein. For example, Internet2 can support data rates in the range of approximately 100 Mbps to several gigabytes per second. Transmission technologies suitable for use in various exemplary appliances optionally include those which are sometimes referred to as gigabit Ethernet and/or fast Ethernet.

Another exemplary digital data I/O option for use in an exemplary appliance includes one or more peripheral component interconnects (PCIs). As a standard, a PCI specifies a 64-bit bus, which is optionally implemented as a 32-bit bus that operates at clock speeds of 33 MHz or 66 MHz. At 32 bits and 33 MHz, it yields a throughput rate of approximately 1 Gbps whereas at 64 bits and 66 MHz, yields a significantly higher throughput rate.

Yet another exemplary digital data I/O option for use in an exemplary appliance includes one or more serial buses that comply with the FireWire standard, which is a version of IEEE 1394, High Performance Serial Bus. A FireWire serial bus provides a single plug-and-socket connection on which up to 63 devices can be attached with data transfer speeds up to, for example, 400 Mbps. The standard describes a serial bus or pathway between one or more peripheral devices and a computer processor.

An exemplary parallel digital data I/O option for use in an exemplary appliance includes one or more small computer system interfaces (e.g., SCSI). One of the latest SCSI standards, Ultra-2 SCSI, has a 16-bit bus that can transfer data at up to approximately 640 Mbps. An Ultra-3 SCSI standard provides even higher transfer rates.

Various exemplary units and/or exemplary appliances optionally provide bit streams at a variety of rates. Such bit streams optionally include video data having a pixel by line format and/or a frame rate that corresponds to a common digital video format as listed in Table 1 below. Table 1 presents several commonly used digital video formats, including 1080×1920, 720×1280, 480×704, and 480×640, given as number of lines by number of pixels; also note that rate (s⁻¹) is either fields or frames.

TABLE 1
Common Digital Video Formats

| | | | Rate | Sequence |
|---|---|---|---|---|
| Lines | Pixels | Aspect Ratio | s⁻¹ | p or i |
| 1080 | 1920 | 16:9 | 24, 30 | Progressive |
| 1080 | 1920 | 16:9 | 30, 60 | Interlaced |
| 720 | 1280 | 16:9 | 24, 30, 60 | Progressive |
| 480 | 704 | 4:3 or 16:9 | 24, 30, 60 | Progressive |
| 480 | 704 | 4:3 or 16:9 | 30 | Interlaced |
| 480 | 640 | 4:3 | 24, 30, 60 | Progressive |
| 480 | 640 | 4:3 | 30 | Interlaced |

Regarding high definition television (HDTV), formats generally include 1,125 line, 1,080 line and 1,035 line interlace and 720 line and 1,080 line progressive formats in a 16:9 aspect ratio. According to some, a format is high definition if it has at least twice the horizontal and vertical resolution of the standard signal being used. There is a debate as to whether 480 line progressive is also “high definition”; it provides better resolution than 480 line interlace, making it at least an enhanced definition format. Various exemplary methods, devices, systems and/or storage media presented herein cover such formats and/or other formats. Regarding bit rates, an exemplary HD video standard specifies a resolution of 1920 pixel by 1080 line, a frame rate of 24 fps, a 10-bit word and RGB color space with 4:2:2 sampling. Such video has on average 30 bits per pixel and an overall bit rate of approximately 1.5 Gbps. As already mentioned, a SDI/SDTI block may receive digital video data according to a SMPTE specification. While some consider the acronyms “SDI” and “SDTI” standards, as used herein, SDI and/or SDTI include standard and/or non-standard serial digital interfaces. As a standard, “SDI” includes a 270 Mbps transfer rate for a 10-bit, scrambled, polarity independent interface, with common scrambling for both component (ITU-R/CCIR 601) video and composite digital video and four channels of (embedded) digital audio, e.g., for system M (525/60) digital television equipment operating with either 10 bit, 4:2:2 component signals or 4 fsc NTSC composite digital signals, wherein “4 fsc” refers generally to composite digital video, e.g., as used in D2 tape format and D3 tape format VTRs, and stands for four times the frequency of subcarrier, which is the sampling rate used. The “SDI” standard includes use of 75-ohm BNC connectors and coax cable as is commonly used for analog video. The “SDTI” standard includes the SMPTE 305M specification and allows for faster than real-time transfers between various servers and between acquisition tapes, disk-based editing systems, and servers; both 270 Mb and 360 Mb, are supported. With typical real-time compressed video transfer rates in the 18 Mbps to 25 Mbps range, “SDTI” has a larger payload capacity and can accommodate, for example, transfers up to four times normal speed. The SMPTE 305M specification describes the assembly and disassembly of a stream of 10-bit words that conform to “SDI” rules. Payload data words can be up to 9 bits and the 10th bit is a complement of the 9th to prevent illegal “SDI” values from occurring.

The SMPTE 259M specification is associated with the “SDI” standard and includes video having a format of 10 bit 4:2:2 component signals and 4 fsc NTSC composite digital signals. The SMPTE 292M specification includes video having a format of 1125 line, 2:1 interlaced, and sampled at 10 bits yields a bit rate of approximately 1.485 Gbps total and approximately 1.244 Gbps active. The SMPTE 292M specification also includes a format having 8 bit, 4:2:2 color sampling that yields approximately 1.188 Gbps total and approximately 995 Gbps active. In general, the SMPTE 292M specification describes the “SDTI” based upon SMPTE 259M (“SDI”), SMPTE 260 (1125 line 60 field HDTV), and SMPTE 274 (1920×1080 line, 60 Hz scanning).

Another digital serial interface specification is referred to as the Digital Video Broadcast-Asynchronous Serial Interface or DVB-ASI and is used with MPEG-2 transport. The DVB standards board promotes the ASI design as an industry-standard way to connect components such as encoders, modulators, receivers, and multiplexers. The maximum defined data rate on such a link is 270 Mbps, with a variable useful payload that can depend on equipment.

In view of the forgoing discussion on data transmission, an exemplary appliance may transmit video data and/or control data through a variety of data I/O interfaces, standards, specifications, protocols, etc. However, as discussed with reference to the exemplary appliance 100 of FIG. 7, control is optionally provided via an intranet. As already mentioned, use of an intranet allows for use of a framework to effectuate control over various units within an exemplary appliance. Of course, while not required of any particular exemplary appliance, video data is also transmittable, either compressed or uncompressed, via such an intranet.

Exemplary Appliance Including One or More Processor-Based Devices

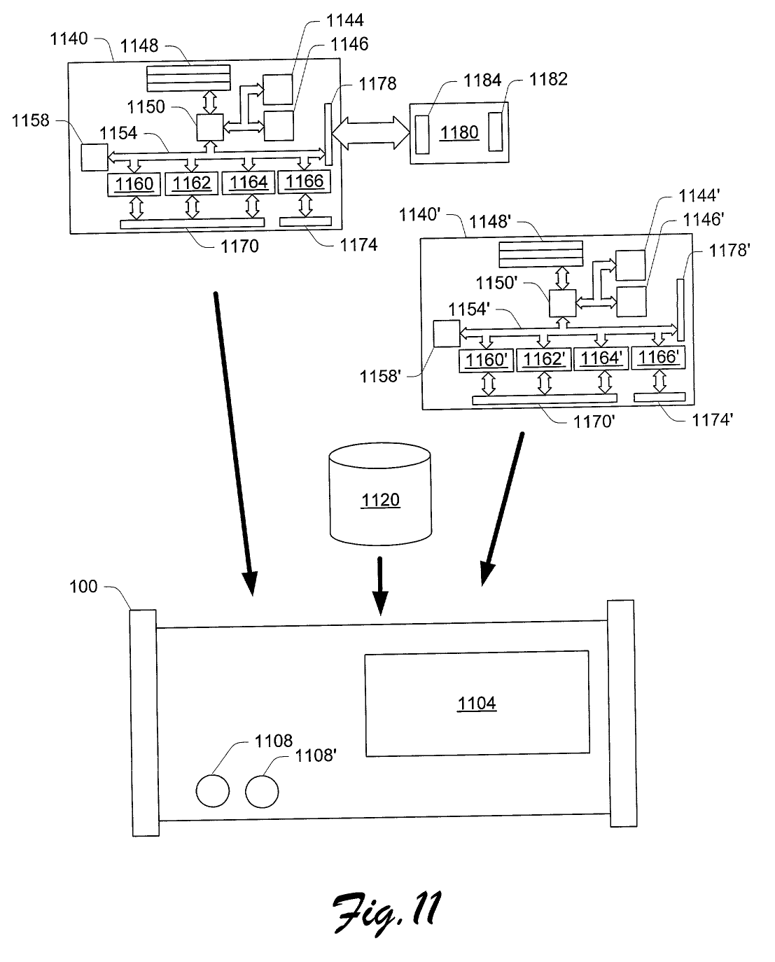

Referring to FIG. 11, a block diagram of an exemplary appliance 100 that includes one or more processor-based devices 1140, 1140′ and storage 1120. As shown, the exemplary appliance 100 includes a display 1104 and/or other UI components 1108, 1108′ and the exemplary appliance is optionally rack mountable (e.g., according to standard 19″ specifications). The processor-based devices 1140, 1140′ are optionally “single board computers” (SBCs). For example, the devices 1140, 1140′ optionally include features found on commercially available SBCs, such as, but not limited to, the GMS HYDRA V2P3 industrial SBC (General Micro Systems, Inc., Rancho Cucamonga, Calif.). The VME-based GMS HYDRA V2P3 SBC includes one or two PENTIUM® III processors with 512 KB of L2 cache per processor; a 100 MHz front side bus for cache and/or other memory operations; and 100 MHz memory block having three SDRAM DIMM modules for up to approximately 768 MB RAM. The GMS HYDRA V2P3 SBC also includes a PCI bus, one or more 10/100Base-Tx Ethernet ports, two serial ports, a SCSI port (e.g., Ultra-Wide SCSI, etc.), and flash BIOS ROM. In general, a VME 32 bit address bus has up to approximately 4 GB of addressable memory and can handle data transfer rates of approximately 40 MBps (approximately 320 Mbps) while a VME64 bus can handle data transfer rates of approximately 80 MBps (approximately 640 Mbps) and a VME64x bus can handle data transfer rates of approximately 160 MBps (approximately 1.28 Gbps). Of course, other VME buses corresponding to more advanced specifications (e.g., VME320 topology and 2eSST protocol bus cycle, etc.) are possible, which include data transfer rates of approximately 320 MBps (approximately 2.56 Gbps) or higher. The GMS HYRDA V2P3 supports VME operations under the WINDOWS® OS with GMS-NT drivers, which provide for sustained data transfer rates of approximately 40 MBps (approximately 320 Mbps). In addition, with an additional transport layer (e.g., TCP/IP), the VME bus is transformable to a network. For example, the GMS VME NT®) (“VME I/P”) provides a TCP/IP transport layer for the GMS NT®/2000 (“VME-Express”) driver and utilities. Use of an additional TCP/IP transport layer (e.g., the GMS VME I/P) allows TCP/IP network protocols to take place, which can eliminate Big/Little Endian and/or transfer size issues. Many VME-based devices include a VME-PCI interface or bridge. For example, the GMS OmniVME bridge is 2eSST and 64-bit, 66MHz PCI 2.2 compliant and can handle data transfer rates up to approximately 533 MBps (approximately 4.3 Gbps).

Referring again to FIG. 11, the processor-based devices 1140, 1140′ include one or more processors 1144, 1146, 1144′, 1146′; RAM 1148, 1148′; one or more bridges 1150, 1154, 1150′, 1154′; and one or more PCI buses 1154, 1154′. Additional communication paths are shown between the one or more processors 1144, 1146, 1144′, 1146′ and respective bridges 1150, 1150′; further, the bridges 1150, 1150′ include communication paths to respective RAM 1148, 1148′. Additional bridges 1158, 1158′ are also shown and optionally have communication paths to other interfaces, memory, etc. as necessary. Also shown are a variety of interfaces 1160-1166, 1160′-1166′, which are in communication with respective PCI buses 1154, 1154′. The interfaces 1160, 1162, 1160′, 1162′ are optionally Ethernet and/or other network interfaces (e.g., network I/Os). Thus, the interfaces 1160, 1162, 1160′, 1162′ optionally handle I/O for fast, gigabit and/or other Ethernet. The interfaces 1164, 1164′ are optionally SCSI and/or other serial and/or parallel interfaces. In addition, such interfaces and/or other interfaces, modules, buses, etc. (e.g., 1178, 1178′) optionally communicate directly and/or indirectly with the storage 1120 1160-1166, 1160′-1166′. As shown, the interfaces link to a respective connector or connectors 1170, 1170′. The additional interface 1166, 1166′ shown in each device 1140, 1140′ is optionally a PCI-VME interface, which links to a respective connector 1174, 1174′. In addition, the PCI buses 1154, 1154′ link to a connector 1178, 1178′, such as, but not limited to, a PMC connector (e.g., PCI Mezzanine card) and/or PMC expansion module. A PMC expansion module typically contains features (e.g., logic, etc.) necessary to bridge a PCI bus, which can allow for configuration during a PCI “plug and play” cycle.

Also shown in FIG. 11, is a serial digital to PCI interface module and/or a serial digital to VME interface module 1180 in communication and/or part of the exemplary processor-based device 1140. This particular module 1180 includes a serial digital interface 1182 for receiving and/or transmitting serial digital data and a PCI interface 1184 for communication with a PCI bus of the device 1140, wherein communication includes receiving and/or transmitting of digital data, including digital video data. For example, a suitable commercially available serial digital to PCI interface module is the VideoPump module (Optibase, San Jose, Calif.). The VideoPump module has a serial digital interface for reception and/or transmission of digital video data (including audio data). The serial digital interface of VideoPump module complies with SMPTE 292M and SMPTE 259M video and SMPTE 299M and SMPTE 272M audio. The “host connection” of the VideoPump module complies with PCI bus 2.1 and 2.2 and can handle 33 MHz and 66 MHz clock domains, 32 bit and 64 bit transfers, and has automatic detection of PCI environment capabilities. The VideoPump module also operates in conjunction with WINDOWS® NT® and/or WINDOWS® 2000® OSs. The VideoPump module supports standard video formats of 1080i, 1080p, 1080sf (SMPTE 274M), 720p (SMPTE 296M) and NTSC serial digital 525 (SMPTE 259M), PAL 625 (ITU-R BT/CCIR 656-3). Of course, other modules, whether serial digital to PCI and/or serial digital to VME may be suitable for use with the processor-based devices 1140, 1140′ and/or other units of the exemplary appliance 100. Further, such modules are optionally capable of operation as PCI to serial digital interfaces and/or VME to serial digital interfaces.

Referring back to the exemplary unit 110 of FIG. 8, an exemplary unit optionally includes a processor-based device such as 1140, 1140′, a serial digital interface module such as 1180 and storage such as 1120. In an exemplary appliance, an encoder unit includes a processor-based device (e.g., 1140 or 1140′) and optionally a serial digital interface module (e.g., 1180); a decoder unit includes a processor-based device (e.g., 1140 or 1140′) and optionally a serial digital interface module (e.g., 1180); a controller unit includes a processor-based device (e.g., 1140 or 1140′); and a server unit includes a processor-based device (e.g., 1140 or 1140′), optionally a serial digital interface module (e.g., 1180) and storage (e.g., 1120). Accordingly, such an exemplary appliance can receive serial digital data via an encoder unit and/or a server unit; structure the digital data to produce structured digital data and/or compress the digital data to produce compressed digital data; and store the structured and/or compressed digital data to storage. Further, such an exemplary appliance can, for example, through use of the decode unit, decode structured and/or compressed digital data and transmit the decoded digital data via a serial digital interface. In addition, control of the various units is achievable through use of the controller unit. The controller unit optionally controls various units via TCP/IP and/or other protocols. Further, the controller unit optionally controls various units using a framework. As already mentioned, such a framework typically includes object-oriented programming technologies and/or tools, which can further be partially and/or totally embedded. Such frameworks include, but are not limited to, the .NET® framework, the ACTIVEX® framework (Microsoft Corporation, Redmond, Wash.), and the JAVA® framework (Sun Microsystems, Inc., San Jose, Calif.). In general, such frameworks rely on a runtime engine for executing code.

Exemplary Controller Unit for Serving an Executable File and/or Code

A block diagram of an exemplary controller unit 180 for controlling various exemplary units is shown in FIG. 12. The exemplary controller 180 includes a network I/O 220″ and a software block 300, which further includes a browser block 328 and various executable file and/or code (EF/C) blocks 360-365. The browser block 328 allows the controller to monitor the status of the exemplary units (e.g., on an intranet) and to serve EF/C blocks and/or other command information. The EF/C_{—}0 block 360 includes code for effectuating a “record” function; the EF/C_{—}1 block 361 includes code for effectuating a “store” function; the EF/C_{—}2 block 362 includes code for effectuating a “compress” function; the EF/C_{—}3 block 363 includes code for effectuating a “play” function; the EF/C_{—}4 block 364 includes code for effectuating a “transmit” function; and the EF/C_{—}5 block 365 includes code for effectuating a “structure” function. Both of the exemplary units 110, 110′ include a network I/O block 220, 220′, RAM blocks 110, 110′, and RE blocks 332, 332′. In addition, one exemplary unit 110, includes a EF/C_{—}2 block 332 for effectuating a “compress” function while the other exemplary unit 110′, includes a EF/C_{—}3 block 332 for effectuating a “play” function. In addition, the exemplary controller unit 180 and the exemplary units 110, 110′ are in communication via communication links, shown as lines between the exemplary units 110, 110′, 180.

According to the exemplary controller unit 180 of FIG. 12, software 300 includes a variety of executable file and/or code blocks for effectuating a variety of functions, such as, for example, those found on a VTR. The exemplary controller unit 180 (e.g., through use of the browser block 328, associated software and/or the network I/O block 220″), serves, or communicates, an executable file and/or code to various exemplary units 110, 110′ as required. For example, as shown, the exemplary controller unit 180 has served a copy of the EF/C_{—}2 362 block to the exemplary unit 110, which is optionally an encoder unit. Upon receipt, the exemplary unit 110 executes the EF/C_{—}2 block 362 using the RE 332. In this particular example, execution of the EF/C_{—}2 block 362 on the exemplary unit 110 (e.g., an encoder unit) effectuates compression of digital video data. In addition, the EF/C_{—}2 block 362 optionally includes data specifying compression parameters (e.g., codec, ratio, bit rate, etc.).

Consider also the exemplary unit 110′, which includes a copy of the EF/C_{—}3 block 363 for effectuating a “play” function. In this example, the controller unit 180 serves a copy of the EF/C_{—}3 block 363 to the exemplary unit 110′ (e.g., a decoder unit). The exemplary unit 110′ receives the EF/C_{—}3 block 363 via the network I/O 220′ and transmits the EF/C_{—}3 block 363 to the RAM block 110′. The RAM block 110′ also includes the operational RE block 332′, which is typically associated with a framework. The RE block 332′ executes the EF/C_{—}3 block 363 to thereby effectuate the “play” function. Note that upon execution of the EF/C_{—}3 block 363, the exemplary unit 110′ may also transmit an executable file and/or code to a storage unit, which, for example, instructs the storage unit to begin transmission of digital video data to the exemplary unit 110′ (e.g., a decoder unit). Of course, the various exemplary units may also instruct other units via other means, which may or may not rely on a network, a framework and/or an RE. For example, the exemplary unit 110′ may optionally instruct a storage unit via an RS-422 interface and receive digital video data via a SCSI interface. In either instance, however, according to the exemplary controller unit 180 of FIG. 12, the “play” function commences typically through execution of an executable file and/or code transmitted via a network.

Regarding the various other exemplary executable file and/or code blocks shown in FIG. 12, the exemplary controller unit 180 optionally serves: the “record” function EF/C_{—}0 block 360 to a storage unit and/or an encoder unit; the “store” function EF/C_{—}1 block 361 to a storage unit and/or an encoder unit; the “transmit” function EF/C_{—}4 block 364 to a storage unit, an encoder unit, and/or a decoder unit; and the “structure” function block to a storage unit, an encoder unit, and/or a decoder unit. Again, a variety of other functions are also possible, which are optionally effectuated via an executable file and/or code served from a controller unit 180 and/or other unit.

Exemplary Method Using Servable Executable Files and/or Code

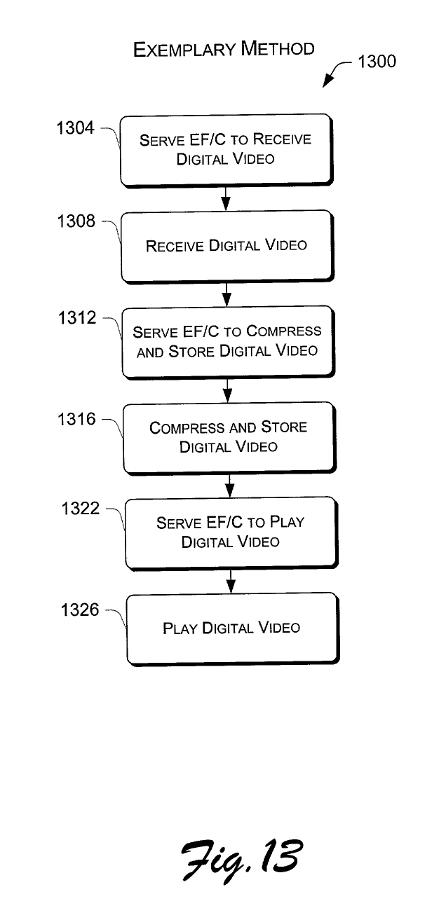

A block diagram of an exemplary method 1300 is shown in FIG. 13. According to the exemplary method 1300, in a serve block 1304, a controller unit of an exemplary appliance serves an executable file and/or code for effectuating reception of digital video data, for example, as provided from a source according to a SMPTE specification. Next, in a reception block 1308, the exemplary appliance receives the digital video data via a SDI/SDTI I/O and optionally stores the data to a storage medium (e.g., in a server unit having associated storage). During and/or after reception, in another serve block 1312, the controller unit of the exemplary appliance serves an executable file and/or code to effectuate compress and store functions. Next, in a compress and store block, the exemplary appliance compresses the digital video data to produce compressed digital video data and stores the compressed digital video data. Next, in yet another serve block 1322, the controller unit of the exemplary appliance serves an executable file and/or code to effectuate a play function. Upon execution of the code, in a play block, the exemplary appliance plays either compressed and/or uncompressed digital video data. For example, the play function optionally instructs a decoder block to request compressed digital video data from a server unit having associated storage and upon receipt of the requested compressed digital video data, the decoder block commences execution of decompression functions to produce uncompressed digital video data suitable for play.

Exemplary NTSC Appliance

A standard NTSC analog color video format includes a frame rate of approximately 30 frames per second (fps), a vertical line resolution of approximately 525 lines, and 640 active pixels per line. Note that the horizontal size of an image (in pixels) from an analog signal is generally determined by a sampling rate, which is the rate that the analog-to-digital conversion samples each horizontal video line. The sampling rate is typically determined by the vertical line rate and the architecture of the camera. Often, the CCD array determines the size of each pixel. To avoid distorting an image, the sampling rate must sample in the horizontal direction at a rate that discretizes the horizontal active video region into the correct number of pixels. For purposes of this example, consider an appliance having an analog-to-digital converter that converts analog video having the aforementioned NTSC format to digital video having a resolution of 640 pixels by 480 lines, a frame rate of 30 fps and an overall bit depth of approximately 24 bits. The resulting bit rate for this digital video data is approximately 220 Mbps. Of course, direct reception of digital video in an NTSC format is also possible.

According to this exemplary appliance, after conversion of the analog video to digital video data, the appliance then structures the data in a format suitable for input to an encoder block, which then compresses the digital video data at a specific and/or an average compression ratio. For example, given a data rate of approximately 220 Mbps, a compression ratio of approximately 50:1 would reduce the data rate to approximately 4.4 Mbps.

Now consider an exemplary appliance having at least two encoders. Such an exemplary appliance may use one encoder to compress the digital video data at a ratio of approximately 400:1 and use another encoder to compress the digital video data at a ratio of approximately 50:1. According to this example, the appliance is capable of communicating compressed digital data at a rate of approximately 550 kbps and also communicating compressed digital data at a rate of approximately 4.4 Mbps. In this example, the lower data rate compressed data may be communicated to a plurality of clients via one interface while the higher data rate compressed data may be communicated to a single client via another interface. Further, network interfaces of the appliance optionally have associated addresses (e.g., an IP address, etc.). Thus, clients may optionally gain access to compressed data over a network via the address.

Exemplary PAL Appliance

A standard PAL analog color video format includes a frame rate of approximately 25 frames per second (fps), a vertical line resolution of approximately 625 lines, and 768 active pixels per line. Consider an exemplary appliance that receives analog video according to this format via an analog-to-digital converter having an appropriate analog interface. In this example, the analog-to-digital converter converts the analog video to digital video data having a resolution of 768 pixels by 576 lines, a frame rate of approximately 25 fps, and an overall color bit-depth of approximately 24 bits. Data in this format has a corresponding data rate of approximately 270 Mbps. Of course, direct reception of digital video in a PAL format is also possible.

According to this exemplary appliance, after conversion of the analog video to digital video data, the converter then structures the data in a format suitable for input to an encoder, which then compresses the digital video data at a specific and/or an average compression ratio. For example, given a data rate of approximately 270 Mbps, a compression ratio of approximately 50:1 would reduce the data rate to approximately 5.3 Mbps.

Now consider an exemplary appliance having at least two encoders. Such an exemplary appliance may use one encoder to compress the digital video data at a ratio of approximately 400:1 and use another encoder to compress the digital video data at a ratio of approximately 50:1. According to this example, the appliance is capable of communicating compressed digital data at a rate of approximately 660 kbps and also communicating compressed digital data at a rate of approximately 5.3 Mbps. In this example, the lower data rate compressed data may be communicated to a plurality of clients via one interface while the higher data rate compressed data may be communicated to a single client via another perhaps exclusive interface. Further, network interfaces of the appliance optionally have associated addresses (e.g., an IP address, etc.). Thus, clients may optionally gain access to compressed data over a network via the address.

Exemplary Non-Standard Resolution Appliance

Consider an exemplary appliance that receives digital video data according to a format having a resolution of 1292 pixel by 966 pixel, a frame rate of approximately 24 fps, and an overall color bit-depth of approximately 24 bits. Data in this format has a corresponding data rate of approximately 720 Mbps.

According to this exemplary appliance, after receiving the digital video data, the appliance then structures the data in a format suitable for input to an encoder, which then compresses the digital video data at a specific and/or an average compression ratio. For example, given a data rate of approximately 720 Mbps, a compression ratio of approximately 100:1 would reduce the data rate to approximately 7.2 Mbps.

Now consider an exemplary appliance having at least two encoders. Such an exemplary appliance may use one encoder to compress the digital video data at a ratio of approximately 500:1 and use another encoder to compress the digital video data at a ratio of approximately 100:1. According to this example, the appliance is capable of communicating compressed digital data at a rate of approximately 1.4 Mbps and also communicating compressed digital data at a rate of approximately 7.2 Mbps. In this example, the lower data rate compressed data may be communicated to a plurality of clients via one interface while the higher data rate compressed data may be communicated to a single client via perhaps another exclusive interface. Further, network interfaces of the appliance optionally have associated addresses (e.g., an IP address, etc.). Thus, clients may optionally gain access to compressed data over a network via the address.

Exemplary Appliance Having Synchronization Capabilities

Various exemplary appliances optionally include synchronization capabilities. For example, professional television systems are typically synchronous, e.g., referenced by a common plant synchronization generator. An exemplary appliance having synchronization capabilities optionally synchronizes recovered base band video (e.g., video and/or audio) signals to a signal and/or data from a synchronization generator. In general, various exemplary appliances disclosed herein, and/or functional and/or structural equivalents thereof, optionally have one or more inputs for receiving reference and/or synchronization information. In addition, an exemplary appliance optionally generates reference and/or synchronization information, for internal and/or external use.

Exemplary Appliance Having Video and/or Audio Metadata Capabilities

Various exemplary appliances optionally include video and/or audio metadata (“VAM”) capabilities. Referring to the exemplary encoding process 900 of FIG. 9, a metadata block 904 is shown. While an exemplary appliance having metadata capabilities is not limited to the process 900 of FIG. 9; the process 900 serves as an example of VAM capabilities. In this example, VAM are optionally processed along with video and/or audio data and/or stored. The VAM are then optionally communicated to a decoder or an audio output and/or display device. Exemplary decoders and/or devices optionally output base band audio and/or video to a system such as a professional television system. Exemplary appliances having VAM capabilities optionally receive VAM via one input and receive video and/or audio via one or more different inputs. Further, exemplary appliances having VAM capabilities optionally output VAM via one output and output video and/or audio via one or more different outputs. A variety of exemplary input and/or output modules are shown in the exemplary appliance 100 of FIG. 2.

An exemplary appliance having VAM capabilities may also have a communication link (e.g., direct or indirect) to a server. For example, a server may transmit VAM to an appliance and/or receive VAM from an appliance. Such a server may also have communication links to other appliances, input devices and/or output devices.

A camera or a telecine optionally include an encoder unit (e.g., the encoder unit 120 of FIG. 1, etc.) and have an output and/or an input for VAM. A camera or a telecine may also optionally include a server unit and/or a controller unit (e.g., the server unit 140 and the controller unit 180 of FIG. 1, etc.) and have an output and/or an input for VAM. A media player (e.g., for TV on air playback, kiosk operations, editorial monitoring, etc.) optionally includes a server unit and/or a decoder unit (e.g., the server unit 140 and the decoder unit 160 of FIG. 1, etc.) and has an output and/or an input for VAM. Such cameras, telecines and media players optionally communicate with a server, which optionally supplies VAM.

Exemplary Network Environments Including One or More Appliances

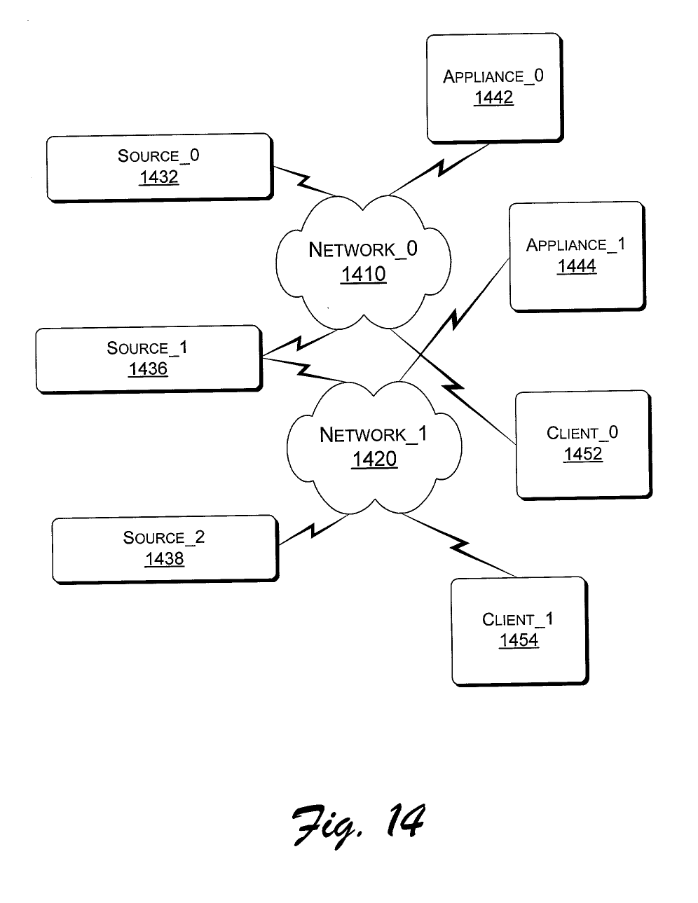

Referring to FIG. 14, a block diagram of an exemplary network environment is shown. The environment includes two networks, network_{—}0 1410 and network_{—}1 1420. Three video source blocks are also shown, source_{—}0 1432 connected to network_{—}0 1410; source_{—}1 1436 connected to network_{—}0 1410 and network_{—}1 1420; and source_{—}2 1438 connected to network_{—}1 1420. The environment also includes two appliances, appliance_{—}0 1442 connected to network_{—}0 1410 and appliance_{—}1 1444 connected to network_{—}1 1420. The environment further includes two clients, client_{—}0 1452 connected to network_{—}0 1410 and client_{—}1 1454 connected to network_{—}1 1420. While only two networks, three sources, two appliances and two clients are shown, it is understood that a variety of arrangements are possible and that appliances_{—}0 1442 and appliance_{—}1 1444 may also be connected directly and/or to a same network.

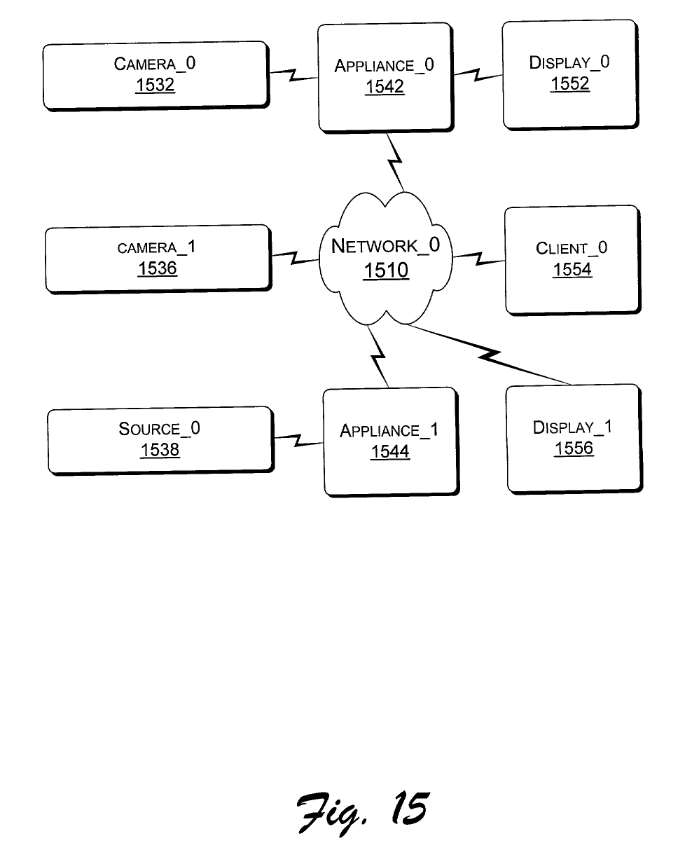

Referring to FIG. 15, a block diagram of another exemplary network environment is shown. The environment includes a network, network_{—}0 1510; three video source blocks, camera_{—}0 1532, camera_{—}1 1536 and source_{—}0 1538; two appliances, appliance_{—}0 1542 and appliance_{—}1 1544; two display units, display_{—}0 1552 and display_{—}1 1556; and a client_{—}0 1554. As shown, the appliance_{—}0 1542 has communication links with the camera₀ 1532, the network_{—}0 1510 and the display 0 1552. The appliance_{—}0 1542 includes, for example, a controller that optionally controls the camera_{—}0 1532 and/or the display_{—}0 1552. For example, an exemplary system having one or more cameras, an appliance, and one or more displays optionally includes communication links that form an intranet. In such an exemplary system, a controller optionally controls the system by serving an executable file and/or code via the intranet. Of course, information regarding control may originate outside an appliance and be provided to the appliance via an appropriate input and/or communication link. Cameras, camera converters, displays and/or display adaptors having framework capabilities are disclosed in the above-referenced co-pending patent application (Attorney Docket No. MS1-1081US), which is incorporated herein by reference.

The appliance_{—}0 1542 and the appliance_{—}1 1544 may also receive input from the camera_{—}1 1536 via the network_{—}0 1510. The appliance_{—}0 and the appliances_{—}1 1544 may output video and/or audio to the display_{—}1 and/or the client_{—}0 via the network_{—}0 1510. Of course, the environment of FIG. 15, may optionally include a variety of other appliances, networks, cameras, sources, clients and/or displays. For example, the environment of FIG. 15, optionally includes a VTR, e.g., as a source and/or a client. Further, a variety of transport and/or transmission capabilities may be included in such an environment.

Exemplary Framework Capabilities and Interoperability

As already mentioned, various exemplary methods, devices and/or systems optionally include framework capabilities that allow for control and/or interoperability. Framework capabilities optionally include global and/or local use of a standard or standards for interoperability. Such standards for data interoperability include, but are not limited to, Extensible Markup Language (XML), Document Object Model (DOM), XML Path Language (XPath), Extensible Stylesheet Language (XSL), Extensible Style Language Transformations (XSLT), Schemas, Extensible Hypertext Markup Language (XHTML), etc. In addition, framework capabilities optionally include use of Component Object Model (COM), Distributed Component Object Model (DCOM), Common Object Request Broker Architecture (CORBA), MICROSOFT® Transaction Server (MTS), JAVA® 2 Platform Enterprise Edition (J2EE), Simple Object Access Protocol (SOAP), etc. to implement interoperability. For example, use of SOAP can allow an application running in one operating system to communicate with an application running in the same and/or another operating system by using standards such as the World Wide Web's Hypertext Transfer Protocol (HTTP) and Extensible Markup Language (XML) for information exchange. Such information optionally includes, but is not limited to, video, audio and/or metadata (VAM) information.

Various exemplary methods, devices and/or appliances optionally use XML in conjunction with XML message-passing guidelines to provide interoperability. For example, an initiative using BIZTALK® software (Microsoft Corporation) includes XML message-passing guidelines that facilitate sharing of data in a computing environment. In general, BIZTALK® software can allow for development and management of processes in a computing environment. By supporting traditional Web technologies such as XML and SOAP, BIZTALK® software can leverage open standards and/or specifications in order to integrate disparate applications independent of operating system, programming model or programming language. Of course, other software may also leverage such standards and/or specifications to achieve a desired level of integration and/or interoperability.

Framework capabilities may also include use of a variety of interfaces, which are implemented to expose hardware and/or software functionality of various units and/or components. For example, a non-linear editing (NLE) device may implement an application programming interface (API) that exposes hardware and/or software functionality. In this example, the API is optionally associated with a framework (e.g., a framework capability), such as, but not limited to, the .NET™ framework, and allows a controller (or other unit) to access functionality of the NLE device. In such an exemplary system, framework capabilities may expose types, classes, interfaces, structures, modules (e.g., a collection of types that can be simple or complex), delegates, enumerations, etc. and framework capabilities may also use rich metadata describing types and dependencies. Of course, other manners of exposing hardware and/or software functionality may be suitable, such as, those that involve use of a COM dynamic-link library (DLL) wherein COM classes optionally expose COM interfaces.

Exemplary Architecture Supporting Interoperability

Various exemplary methods, devices and/or systems optionally include, and/or operate in conjunction with, an architecture that supports local and/or global interoperability. For example, a data architecture may accommodate objectives such as fault tolerance, performance, scalability and flexibility for use in media acquisition, production and/or broadcast environments. In this example, the data architecture has one or more layers, such as, but not limited to, an application layer, a storage area network (SAN) layer, a digital asset management (DAM) layer and/or a control and/or messaging layer.

In a multilayer architecture, while a fully partitioned data model is possible (e.g., ISO/OSI Network Model), strengths implicit in one layer are optionally exploited to mitigate weaknesses of another layer. For example, functions and/or methods in a data architecture optionally overlap between layers to provide a greater degree of flexibility and redundancy from both an implementation and operational perspective. In such an overlapping architecture, various layers may operate to provide data storage at the application/service layer, the SAN layer and/or the DAM layer. Metadata storage and transport may be implemented peer to peer, via SAN constructs or via the DAM layer. In addition, an application optionally includes some degree of intrinsic business processes automation (BPA) capability (e.g. photoshop scripting), also consider an exemplary DAM implementation having such capabilities via workflow metaphors. BIZTALK® software of course, may represent a more highly abstracted means of BPA implementation.

In general, an application layer includes applications and/or other functionality. Such applications and/or functionality are optionally provided in a computing environment having units and/or components that rely on one or more platforms and/or operating systems. In a typical computing environment, or system, such units and/or components optionally operate autonomously, synchronously and/or asynchronously.

A typical SAN layer may include on-line, nearline, and/or offline storage sites wherein files across storage sites are optionally presented as a standard file system. A SAN layer optionally exposes itself as a unified storage service. Further, a SAN layer may allow for synchronization between a local application and/or other functionality and the SAN layer.

An exemplary DAM layer optionally includes content and/or archival management services. For example, a DAM layer may provide for abstraction of digital assets from files into extended metadata, relationships, versioning, security, search and/or other management related services. A DAM layer optionally includes APIs and/or other interfaces to access hardware and/or software functionality. For example, an exemplary DAM layer specifies one or more APIs that expose functionality and allow for any degree of local and/or global interoperability. Such interoperability may allow for management and/or workflow integration across one or more computing environments. For example, a DAM layer may provide digital asset library management services or digital media repository management services that allow for data distribution and/or access to one or more computing environments (e.g., client environments, production environments, post-production environments, broadcast environments, etc.).

A control and/or messaging layer optionally includes enterprise applications integration (EAI) and/or business process automation (BPA). For example, such a layer may implement software, such as, but not limited to, BIZTALK® software. A control and/or messaging layer optionally leverages framework capabilities locally and/or globally by using such software. In general, a control and/or messaging layer can support units and/or components, in one or more computing environments, in a platform independent manner.

Thus, as described herein, various exemplary video appliances, such as the video appliance 100, are suitable for use in a multilayered architecture. For example, to operate in conjunction with a DAM layer, an exemplary appliance may include APIs to expose hardware and/or software functionality beyond the appliance (e.g., to one or more other computing environments). An exemplary appliance may also communicate VAM via operation of one or more layers. Further, an exemplary appliance optionally serves as the core of a SAN layer and/or a control and/or messaging layer. In general, an exemplary appliance may include an internal multilayer architecture that supports interoperability of internal units and/or components; however, an exemplary appliance may operate in conjunction with and/or support a multilayer architecture that extends beyond the appliance as well.

Exemplary Uses in Professional and/or Other Sectors

Various exemplary methods and/or exemplary devices described herein are suitable for use in professional and/or other sectors that rely on video and/or audio information. In particular, such exemplary methods and/or exemplary devices may enhance of acquisition, processing and/or distribution. Table 2 shows sector type along with acquisition, processing and distribution features that may pertain to a given sector type.

TABLE 2
Types of Sectors and Exemplary Characteristics

| Type | Acquisition | Processing | Distribution |
|---|---|---|---|
| Broadcast | Approx. 95% contribution | Editorial | SDTV |
| | Approx. 5% mastering | Temporal | HDTV |
| | Real-time, reliability, | Compositing | Network |
| | durability | | |
| HD/Film | Approx. 95% mastering | Compositing | Theatrical |
| | Approx. 5% contribution | Color | VHS |
| | Quality | Editorial | DVD |
| | | Telecine | Airline |
| | | | Hotel |
| Corporate | Approx. 50% contribution | Editorial | TVPN |
| Industry | Approx. 50% consumption | | VHS |
| | Real-time, inexpensive | | |
| Government | Approx. 50% contribution | False color | Secure Net |
| Science | Approx. 50% mastering | Histographic | Video |
| | Standards-based, secure | Overlays | |
| | platforms | Temporal | |
| | | Database | |
| Security | Approx. 100% consumption | Quad split | Monitor |
| | Reliable, inexpensive | Multi-cam | VHS |
| | | Switch | |

In Table 2, “mastering” refers generally to a video quality such as full bandwidth RGB or film negative. Mastering quality is suitable for seamless compositing (e.g., multilayered effects), such as blue screens, etc. “Contibution” refers generally to a video quality that is slightly compressed, for example, to YUYV and/or component analog. “Consumption” refers generally to a video quality associated with typical over-the-air or cable television and also includes DVD, VHS and/or composite analog.

Various exemplary methods, devices and/or systems are suitable for meeting the needs of the sectors presented in Table 2. For example, an exemplary appliance is suitable for use in a security system having cameras that generate, for example, quad-screen format video. Such an exemplary appliance has inputs for the cameras and processes information received from the cameras to generate quad-screen format video for storage and/or display. Another exemplary appliance is suitable for use in a high definition broadcast of a sporting event, such as a football game. In this example, the exemplary appliance has inputs for a plurality of cameras (e.g., 10 or more cameras), processing capabilities of the exemplary appliance allow a director to view and select video from any camera and route selected video to a transmitter or the like for distribution. Yet another exemplary appliance is suitable for use in production of a commercial. In this example, film images are converted to digital images on a telecine, then the exemplary appliance receives the digital images (e.g., video) from the telecine. The exemplary appliance allows for further processing (e.g., editing, structuring, compressing, etc.) and subsequent storage and/or transmission. Of course, the foregoing examples are not exclusive since various exemplary methods, devices, and/or systems are, in general, extensible and flexible to suit a wide variety of uses. According to various exemplary methods, devices, and/or systems, applications such as non-linear editors, on-air servers, etc. can access and/or receive video and/or audio data from an exemplary appliance in a variety of formats, including native file format(s), base band format(s), etc.

Communication to an Exemplary Recorder

In various exemplary methods, devices and/or systems, an appliance (e.g., the exemplary appliance 100 of FIG. 1, etc.) optionally transmits digital video data to a CD recorder and/or a DVD recorder. The CD and/or DVD recorder then records the data, which is optionally encoded or compressed and/or scaled to facilitate playback on a CD and/or DVD player. DVD players can typically play data at a rate of 10 Mbps; however, future players can be expected to play data at higher rates, e.g., perhaps 500 Mbps. In this particular example, the appliance optionally scales the video data according to a DVD player specification (e.g., according to a data rate) and transmits the scaled data to a DVD recorder. The resulting DVD is then playable on a DVD player having the player specification. According to such a method, encoding or compression is not necessarily required in that scaling achieves a suitable reduction in data rate. In general, scaling is a process that does not rely on a process akin to compression/decompression (or encoding/decoding) in that information lost during scaling is not generally expected to be revived downstream. Where encoding or compression is used, a suitable compression ratio is used to fit the content onto a DVD disk or other suitable disk.

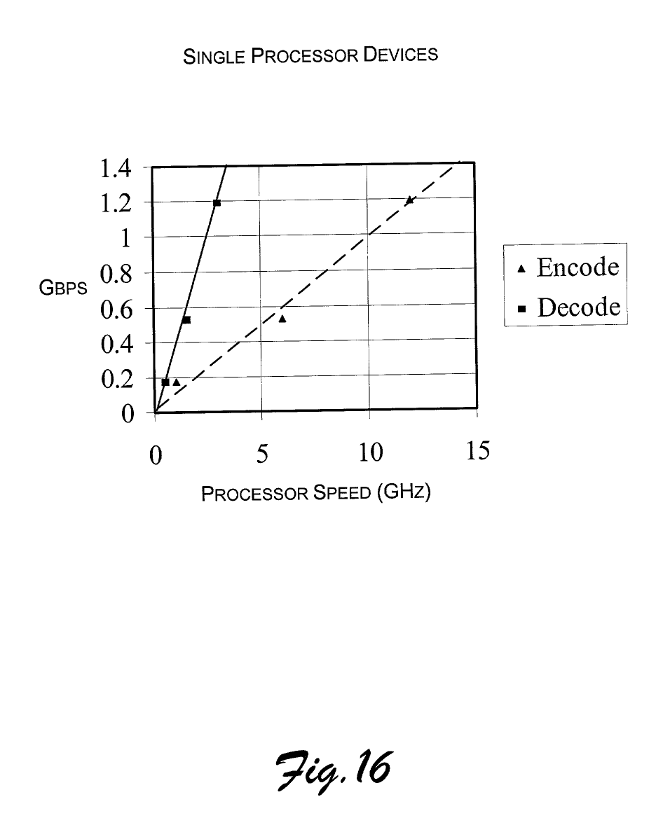

Regarding decompression, e.g., in a decoder unit and/or another unit, decompressed digital data optionally include video data having an image and/or frame rate format selected from the common video formats listed in Table 1, for example, digital data optionally have a 1280 pixel by 720 line format, a frame rate of 24 fps and a bit depth of approximately 24. In this example, a decoder unit includes a processor, such as, but not limited to, a PENTIUM® processor (Intel Corporation, Delaware) having a speed of 1.4 GHz (e.g., a PENTIUM® III processor). Consider another example wherein decompressed digital data optionally have a 1920 pixel by 1080 line image format, a frame rate of 24 fps and a bit depth of approximately 24 bits. Yet another exemplary decoder unit has two processors, wherein each processor has a speed of greater than 1.2 GHz, e.g., two AMD® processors (Advanced Micro Devices, Incorporated, Delaware). In general, a faster processor speed allows for display of a higher resolution image format and/or a higher frame rate. FIG. 16 is a graph of bit rate in Gbps (ordinate, y-axis) versus processor speed for a processor-based device (e.g., a computer, smart device, etc.) having a single processor (abscissa, x-axis). The graph shows data for encoding video and for decoding video. Note that the data points lay along approximately straight lines in the x-y plane (a solid line is shown for decoding and a dashed line is shown for encoding). A regression analysis shows that decoding has a slope of approximately 0.4 Gbps per GHz processor speed and that encoding has a slope of approximately 0.1 Gbps per GHz processor speed. In this particular graph, it is apparent that, with reference to the foregoing discussion, that resolution, frame rate and color space need not adhere to any specific format and/or specification. The ordinate data was calculated by multiplying a pixel resolution number by a line resolution number to arrive at the number of pixels per frame and then multiplying the pixels per frame number by a frame rate and the number of color information bits per pixel. Thus, according to various exemplary methods, devices and/or systems described herein, encoding and/or decoding performance characteristics, if plotted in a similar manner would produce data lying approximately along the respective lines as shown in FIG. 16. Thus, according to various aspects of exemplary methods, devices and/or systems described herein, a processor-based device having an approximately 1.5 GHz processor can decode encoded video at a rate of approximately 0.6 Gbps, e.g., 1.5 GHz multiplied by 0.4 Gbps/GHz, and therefore, handle video having a display rate of approximately 0.5 Gbps, e.g., video having a resolution of 1280 pixel by 720 line, a frame rate of 24 frames per second and a color bit depth of 24 bits. Note that for decoding, the rate is given based on a video display format and not on the rate of data into the decoder. In addition, while the abscissa of the graph in FIG. 16 terminates at 15 GHz, predictions based on Moore's Law suggest that processor speeds in excess of 15 GHz can be expected; thus, such processors are also within the scope of the exemplary methods, systems, devices, etc. disclosed herein.

Video Quality

Various exemplary methods, devices, systems, and/or storage media discussed herein are capable of providing quality equal to or better than that provided by MPEG-2, whether for DTV, computers, DVDs, networks, etc. One measure of quality is resolution. Regarding MPEG-2 technology, most uses are limited to 720 pixel by 480 line (345,600 pixels) or 720 pixel by 576 line (414,720 pixels) resolution. In addition, DVD uses are generally limited to approximately 640 pixel by 480 line (307,200 pixels). Thus, any technology that can handle a higher resolution will inherently have a higher quality. Accordingly, various exemplary methods, devices, systems, and/or storage media discussed herein are optionally capable of handling a pixel resolution greater than 720 pixels and/or a line resolution greater than approximately 576 lines. For example, a 1280 pixel by 720 line resolution has 921,600 pixels, which represents over double the number of pixels of the 720 pixel by 576 line resolution. When compared to 640 pixel by 480 line, the increase is approximately 3-fold. On this basis, various exemplary methods, devices, systems, and/or storage media achieve better video quality than MPEG-2-based methods, devices, systems and/or storage media.

Another quality measure involves measurement of peak signal to noise ratio, known as PSNR, which compares quality after compression/decompression with original quality. The MPEG-2 standard (e.g., MPEG-2 Test Model 5) has been thoroughly tested, typically as PSNR versus bit rate for a variety of video. For example, the MPEG-2 standard has been tested using the “Mobile and Calendar” reference video (ITU-R library), which is characterized as having random motion of objects, slow motion, sharp moving details. In a CCIR 601 format, for MPEG-2, a PSNR of approximately 30 dB results for a bit rate of approximately 5 Mbps and a PSNR of approximately 27.5 dB for a bit rate of approximately 3 Mbps. Various exemplary methods, devices, systems, and/or storage media are capable of PSNRs higher than those of MPEG-2 given the same bit rate and same test data.

Yet another measure of quality is comparison to VHS quality and DVD quality. Various exemplary methods, devices, systems, and/or storage media are capable of achieving DVD quality for 640 pixel by 480 line resolution at bit rates of 500 kbps to 1.5 Mbps. To achieve a 500 kbps bit rate, a compression ratio of approximately 350:1 is required for a color depth of 24 bits and a compression ratio of approximately 250:1 is required for a color depth of 16 bits. To achieve a 1.5 Mbps bit rate, a compression ratio of approximately 120:1 is required for a color depth of 24 bits and a compression ratio of approximately 80:1 is required for a color depth of 16 bits. Where compression ratios appear, one would understand that a decompression ratio may be represented as the reverse ratio.

Yet another measure of performance relates to data rate. For example, while a 2 Mbps bit rate-based “sweet spot” was given in the background section (for a resolution of 352 pixel by 480 line), MPEG-2 is not especially useful at data rates below approximately 4 Mbps. For most content a data rate below approximately 4 Mbps typically corresponds to a high compression ratio, which explains why MPEG-2 is typically used at rates greater than approximately 4 Mbps (to approximately 30 Mbps) when resolution exceeds, for example, 352 pixel by 480 line. Thus, for a given data rate, various exemplary methods, devices, systems, and/or storage media are capable of delivering higher quality video. Higher quality may correspond to higher resolution, higher PSNR, and/or other measures.

While the description herein generally refers to “video” many formats discussed herein also support audio. Thus, where appropriate, it is understood that audio may accompany video. Although some exemplary methods, devices and exemplary systems have been illustrated in the accompanying Drawings and described in the foregoing Detailed Description, it will be understood that the methods and systems are not limited to the exemplary embodiments disclosed, but are capable of numerous rearrangements, modifications and substitutions without departing from the spirit set forth and defined by the following claims.

What is claimed is:

1. A method for processing video data comprising:
serving code for execution on a runtime engine wherein the code includes instructions for compressing digital video data; and
in response to execution of the code, compressing digital video data to produce compressed digital video data.

2. The method of claim 1, wherein the serving includes serving code from a controller unit to an encoder unit capable of compressing digital video data.

3. The method of claim 1, wherein the serving includes serving code via an intranet.

4. The method of claim 1, wherein the serving includes serving code via an intranet from a controller unit to an encoder unit capable of compressing digital video data.

5. The method of claim 1, wherein the code includes instructions for compressing the digital video data at one or more compression ratios.

6. The method of claim 1, wherein the compressing compresses the digital video data using block-based motion predictive coding to reduce temporal redundancy and/or transform coding to reduce spatial redundancy.

7. The method of claim 1, wherein the compressing maintains a PSNR of at least 30 dB.

8. A method of processing video data comprising:
serving code for execution on a runtime engine wherein the code includes instructions for decompressing compressed digital video data; and
in response to execution of the code, decompressing the compressed digital video data to produce decompressed digital video data.

9. The method of claim 8, wherein the serving includes serving code from a controller unit to a decoder unit capable of decompressing compressed digital video data.

10. The method of claim 8, wherein the serving includes serving code via an intranet.

11. The method of claim 8, wherein the serving includes serving code via an intranet from a controller unit to a decoder unit capable of decompressing compressed digital video data.

12. The method of claim 8, wherein the compressed digital video data includes digital video data compressed using block-based motion predictive coding to reduce temporal redundancy and/or transform coding to reduce spatial redundancy.

13. A method of controlling a video appliance having two or more units comprising:
communicating code from a controller unit to another unit wherein the other unit includes a runtime engine; and
executing the code on the runtime engine of the other unit.

14. The method of claim 13, wherein the other unit comprises a unit selected from the group consisting of encoder units, decoder units, and server units.

15. The method of claim 13, wherein the communicating includes communicating via a network.

16. The method of claim 13, wherein the video appliance includes a network and the communicating includes communicating code via the network.

17. A video appliance comprising:
a network;
a first unit in communication with the network and configured to process digital video data and to execute code;
a second unit in communication with the network and configured to store digital video data and to execute code; and
a third unit in communication with the network and configured to communicate code to the first unit and/or to the second unit via the network.

18. The video appliance of claim 17, wherein the first unit comprises an encoder unit configured to compress digital video data and/or a decoder unit configured to decompress compressed digital video data.

19. The video appliance of claim 17, wherein the second unit comprises a server configured to store digital video data.

20. The video appliance of claim 17, wherein the third unit comprises a controller configured to communicate code via the network wherein execution of the code controls the first unit and/or the second unit.

21. The video appliance of claim 17, wherein the network comprises an intranet.

22. The video appliance of claim 17, wherein the third unit is configured to communicate the code in an executable file.

23. The video appliance of claim 17, wherein the code includes intermediate language code.

24. The video appliance of claim 17, wherein the code includes code associated with a framework.

25. The video appliance of claim 17, wherein one or more of the units includes a runtime engine.

26. The video appliance of claim 17, wherein one or more of the units share one or more processors.

27. The video appliance of claim 17, wherein digital video data includes digital video data that complies with a SMPTE specification.

28. The video appliance of claim 17 further comprising a data architecture for supporting interoperability between the one or more units.

29. The video appliance of claim 17, wherein one or more of the units include a runtime engine associated with a framework selected from the group consisting of the .NET™ framework, the ACTIVEX® framework, and the JAVA® framework.

30. A video appliance configured to use one or more network protocols comprising:
a first unit configured to process digital video data and having a PCI—VME interface;
a second unit having associated storage for storing digital video data; and
a third unit configured to communicate code to the first unit and/or to the second unit using the one or more network protocols.

31. The video appliance of claim 30, wherein the first unit comprises an encoder unit configured to compress digital video data and/or a decoder unit configured to decompress compressed digital video data.

32. The video appliance of claim 30, wherein the second unit comprises a server configured to store digital video data.

33. The video appliance of claim 30, wherein one or more of the units includes a runtime engine capable of executing the code.

34. A video appliance comprising:
a first unit configured to process digital video data and having a PCI to SDI interface module;
a second unit having associated storage for storing digital video data; and
a third unit configured to control the first unit and the second unit through use of code communicated via a network.

35. The video appliance of claim 34, wherein the PCI to SDI interface complies with one or more SMPTE specifications for transmission of digital video data.

36. The video appliance of claim 34, wherein the first unit comprises an encoder unit configured to compress digital video data and/or a decoder unit configured to decompress compressed digital video data.

37. The video appliance of claim 34, wherein the second unit comprises a server configured to store digital video data.

38. The video appliance of claim 34, wherein one or more of the units includes a runtime engine capable of executing the code.

39. A video appliance having an intranet comprising:
a first unit for encoding and/or decoding digital video data via software-based encoding and/or decoding;
a second unit having associated storage for storing digital video data; and
a third unit configured to control the first unit and the second unit through software communicated via the intranet.

40. A video appliance comprising:
processor means for processing digital video data;
storage means for storing digital video data;
control means for controlling the processor means and the storage means via communicable code; and
communication means for communicating communicable code from the control means to the processor means and the storage means.

41. The video appliance of claim 40, wherein the processor means for processing digital video data comprises an encoder unit and/or a decoder unit.

42. The video appliance of claim 40, wherein the storage means for storing digital video data comprises a server unit.

43. The video appliance of claim 40, wherein the control means comprises a controller unit.

44. The video appliance of claim 40, wherein the communication means comprises a network having one or more communication links between the processor means, the storage means and the control means.

45. The video appliance of claim 44, wherein the network comprises an intranet.

46. A video appliance comprising:
communication means for communicating code for execution on a runtime engine wherein the code includes instructions for compressing digital video data; and
compression means for compressing digital video data to produce compressed digital video data.

47. The video appliance of claim 46, wherein the communication means comprises an intranet.

48. The video appliance of claim 46, wherein the compression means comprises an encoder unit.

49. A video appliance comprising:
communication means for communicating code for execution on a runtime engine wherein the code includes instructions for decompressing digital video data; and
decompression means for decompressing compressed digital video data to produce decompressed digital video data.

50. The video appliance of claim 49, wherein the communication means comprises an intranet.

51. The video appliance of claim 49, wherein the decompression means comprises a decoder unit.

52. A video appliance comprising:
an intranet; and
a data architecture having one or more layers selected from the group consisting of application layers, storage area network layers, digital asset management layers and control and/or messaging layers.
